(19) United States
(12) Patent Application Publication
(10) Pub. No.: US 2024/0042971 A1
(43) Pub. Date: Feb. 8, 2024

(54) SURFACE-MOUNTABLE RETRACTABLE TRAILER STAND ASSEMBLY

(71) Applicant: IDEAL WAREHOUSE INNOVATIONS, INC., Vaughn (CA)

(72) Inventors: Joseph J. DI BIASE, Vaughn (CA); Sean MILLER, Vaughn (CA)

(21) Appl. No.: 18/268,853

(22) PCT Filed: Dec. 22, 2021
(86) PCT No.: PCT/CA2021/051868

§ 371 Date: Jun. 21, 2023

Related U.S. Application Data
(60) Provisional application No. 63/129,208, filed on Dec. 22, 2020.
(60) Provisional application No. 63/210,674, filed on Jun. 15, 2021.

(51) Int. Cl. B60S 9/10

(52) U.S. Cl. CPC B60S 9/10

(57) ABSTRACT

The present invention relates to a surface-mountable retractable trailer stand assembly for supporting a trailer parked at a loading dock. In an embodiment, the assembly comprises a base for mounting to a surface, one or more moveable support members attached to the base. The one or more moveable support members are moveable between a first lowered stored position wherein the one or more moveable support members are retracted towards the surface, and a second raised operable position wherein the one or more moveable support members are extended away from the surface and are capable of supporting a trailer.

### FIELD OF THE INVENTION

The present invention relates to trailer stands for supporting the trailers of semi-tractor-trailer trucks parked at loading docks and more particularly to surface-mountable trailer stand assemblies comprising one or more moveable support members extendable away from the surface and capable of supporting a trailer and retractable towards the surface for storage when not in use.

### BACKGROUND OF THE INVENTION

A semi-tractor-trailer truck is the combination of a tractor unit and one, or more, semi-trailers to carry freight, wherein the semi-trailer attaches to the tractor unit with a type of hitch called a fifth-wheel. A semi-tractor-trailer truck is variously known as a transport truck, semi-trailer truck, tractor-trailer truck, semi-tractor truck, semi-truck, trailer truck, tractor truck, transfer truck, articulated truck, artic, single truck, semi-tractor-trailer, semi-trailer, tractor-trailer, semi-tractor, semi, trailer, tractor, big rig, eighteen-wheeler or articulated lorry, depending on the country and region.

Semi-trailers comprise landing gear that allow for the raising, lowering and support of the forward end or nose portion of the trailer in the engagement and disengagement from the tractor unit (also called a prime mover) and allows the trailer to be freestanding whilst not in transit. In most instances, the trailer itself is decoupled from a prime mover and then re-coupled to either the same prime mover, a different prime mover, a shunt truck, a converter dolly etc., depending on the logistics appropriate to the use.

A typical scenario is where a trailer is delivered to a loading dock for loading or unloading. The prime mover positions the trailer in the loading dock. The operator will de-latch the kingpin from the fifth wheel (alternatively known as the turntable) and disconnect the service lines. The operator will then manually lower the legs of the landing gear. The operator will then raise the forward end of the trailer to clear the trailer king pin from the fifth wheel of the prime mover. Once the trailer king pin is clear of the prime mover fifth wheel, the prime mover can be driven clear of the trailer to leave the trailer freestanding. The prime mover is then typically utilized elsewhere in a more productive role than being idle whilst the trailer is loaded or unloaded. The trailer will then be loaded or unloaded which may take a portion of an hour or it may take several days. The trailer will typically be loaded up to twenty tons in weight, and in some instances up to twenty-five tons, on one trailer. Once the trailer is loaded or unloaded, a prime mover will then return to the trailer for removal of the trailer from the loading dock.

When a fork-truck loads or unloads at the front of a trailer, the trailer can become nose heavy. Under certain conditions of loading or unloading, there is a potential for the landing gear of the trailer, especially if faulty or rusted, to collapse under extreme weight conditions resulting in the trailer nose diving or tipping over. An unsupported trailer can collapse or tip over, for example, with fork-truck and driver inside, creating a hazardous situation for the fork truck driver, as well as for any personnel on the ground around the outside of the trailer. Trailer nose diving or tip over can be very costly with injuries to employees, downtime, and loss of product.

Currently, devices known as “trailer jacks” or “trailer stands” are often used to act as a safety support under the front end or nose portion of a trailer when it is being loaded or unloaded with the trailer resting on its landing gear rather than on a tractor, converter dolly, shunt truck etc. Current trailer stands require personnel to position them, and remove them from, under the nose portion of the trailer either directly (i.e., manually) or indirectly via, for example, a shunt truck. This leaves the operating personnel in a vulnerable and dangerous position around and/or under the trailer, especially if it were to tip over or nosedive.

Therefore, there is a need for an easy-to-use, reliable trailer stand support that is capable of supporting a trailer if and when its landing gear collapses and preventing such a trailer from tipping over or nose diving, which trailer stand does not require personnel to position the trailer stand under, or to remove the trailer stand from underneath, the trailer.

### SUMMARY OF THE INVENTION

The present invention overcomes the disadvantages of, and problems associated with, prior art trailer stands, including currently manually positioned trailer stands.

In accordance with an aspect of the present invention, there is provided a surface-mountable retractable trailer stand assembly comprising at least one moveable support member that when raised to its operable position underneath the nose portion of a trailer, is capable of supporting the trailer and that when lowered into its stored position, provides a safe working environment for vehicular and foot traffic on the driveway of the loading dock.

In an embodiment, the surface-mountable retractable trailer stand comprises a housing which creates a receptacle, cavity or enclosure within and when the at least one moveable support member is lowered into its stored position, it provides a cover for the receptacle, cavity or enclosure. Such a cover may prevent water, snow, ice, debris etc. from entering the receptacle, cavity or enclosure.

In accordance with an aspect of the present invention, there is provided a surface-mountable retractable trailer stand assembly comprising a first moveable support member and a second moveable support member, wherein the first and second moveable support members are moveable between a lowered position wherein the moveable support members are retracted towards the surface in their stored position and a raised operable position wherein the moveable support members are extended away from the surface and are in their supporting position to support the trailer to be supported.

In accordance with an aspect of the present invention, there is provided a surface-mountable retractable trailer stand assembly comprising: a base for mounting to the surface, one or more moveable support members attached to the base, wherein the at least one moveable support member is moveable between a lowered position wherein the at least one moveable support member is retracted towards the surface in a stored position, and a second raised operable position wherein the at least one moveable support member is extended away from the surface in an operable position wherein it is capable of supporting a trailer.

In accordance with an aspect of the present invention, there is provided a surface-mountable retractable trailer stand assembly comprising: a base for mounting to the surface and one or more moveable support members attached to the base. In an embodiment, the one or more moveable support members are selectively moveable between a lowered, retracted, closed or stored position, wherein the one or more moveable support members are retracted such that they are positioned substantially parallel to the mounted surface and do not interfere with loading dock personnel or traffic, and a raised, extended, open or operable position, wherein the one or more moveable support members are extended such that they are positioned substantially orthogonal to the mounted surface and are capable of supporting a trailer if and when its landing gear collapses and preventing such a trailer from tipping over or nose diving. In an embodiment, the one or more moveable support members is a single moveable support member, which when a trailer is parked at the loading dock and the single moveable support member is raised to its second operable position, the single moveable support member is positioned under the approximate center of the trailer substantially equidistant from the sides of the trailer. In another embodiment, the one more moveable support members is a pair of moveable support members, which when a trailer is parked at the loading dock and the pair of moveable support members are raised to their second operable positions, each moveable support member is positioned under the trailer substantially equidistant from the respective sides of the trailer.

In accordance with an aspect of the present invention, there is provided a surface-mountable retractable trailer stand assembly for supporting a trailer, the assembly comprising: (a) a stationary support base for mounting to a surface; and (b) a displaceable support member attached to the stationary support base and moveable between a first surface position to a second above-surface position capable of supporting the trailer.

In an embodiment, the assembly further comprises a moving mechanism associated with the displaceable support member for moving the displaceable support member between the first and second positions.

In an embodiment, the moving mechanism has one end connected to the stationary support base and another end connected to the displaceable support member for moving the displaceable support member between the first and second positions.

In an embodiment, the assembly further comprises a stationary support frame disposed above the stationary support base.

In an embodiment, the assembly further comprises a guide means for guiding the displaceable support member.

In an embodiment, the guide means is provided by the stationary support frame.

In an embodiment, the stationary support base and the stationary support frame form at least part of an enclosure for receiving the displaceable support member and the moving mechanism in the first position.

In an embodiment, the displaceable support member is pivotally attached to the stationary support base.

In accordance with an aspect of the present invention, there is provided a surface-mountable retractable trailer stand assembly for supporting a trailer, the assembly comprising: (a) a stationary support base for mounting to a surface; (b) a displaceable support member co-operating with the stationary support base, and moveable between a first stored position to a second support position so as to be capable of supporting the trailer; and (c) a moving mechanism associated with the displaceable support member for moving the displaceable support member from the first position to the second support position, wherein the moving mechanism is connected at one end to the stationary support base and connected at another end to the displaceable support member for moving the displaceable support member between said positions.

In an embodiment, the assembly further comprises a stationary support frame disposed above the stationary support base.

In an embodiment, the assembly further comprises a guide means for guiding the displaceable support member.

In an embodiment, the guide means is provided by the stationary support frame.

In an embodiment, the stationary support base and the stationary support frame form an enclosure for receiving the displaceable support member and the moving mechanism.

In an embodiment, the cooperation between the displaceable support member and the stationary support base is a pivotal cooperation.

In accordance with an aspect of the present invention, there is provided a surface-mountable retractable trailer stand assembly for supporting a trailer, the assembly comprising: (a) a housing comprising a stationary support base for mounting on a surface and a stationary support frame disposed above the stationary support base; (b) a displaceable support member co-operating with the stationary support base and moveable between a first surface position to a second support position so as to be capable of supporting the trailer; and (c) a moving mechanism associated with the displaceable support member for moving the displaceable support member from the first position, wherein the displaceable support member is contained within the housing to the second support position.

In an embodiment, the displaceable support member comprises a pair of displaceable support members.

In an embodiment, one end of each of the displaceable support members is pivotably attached to the stationary support base and the other end of each of the displaceable support members is displaceable relative to the stationary support base.

In an embodiment, the stationary support frame comprises guide means for guiding the displaceable support member.

In an embodiment, the guide means is adapted to pivotally receive the displaceable support member in the first position.

In an embodiment, the stationary support frame presents an opening and the displaceable support member comprises two rectangular displaceable support members pivotably received by the opening, for movement between the surface position to a second support position so as to be capable of supporting the trailer.

In an embodiment, the moving mechanism is an actuator for moving the first and second displaceable support members between the first in-receptacle position to the second support position.

In an embodiment, the assembly further comprises an enclosure adapted to be disposed upon the base; the enclosure for housing the displaceable support member and moving mechanism.

In an embodiment, the actuator is a linear actuator having one end pivotally connected to the stationary support base, and another end pivotally connected to the displaceable support member.

In accordance with an aspect of the present invention, there is provided a surface-mountable retractable trailer stand assembly for supporting a trailer, the assembly comprising: (a) a housing comprising a lower end in the form of a stationary support base for mounting to a surface and an upper end vertically spaced apart from the lower end in the form of a stationary support frame, wherein the housing provides a receptacle; (b) a pair of displaceable support members moveable within the receptacle, each displaceable support member having a lower end pivotally secured to the lower stationary support base and an upper free end displaceable relative to the stationary support base; and (c) a pair of a moving mechanisms, each moving mechanism associated with one displaceable support member and having one end connected to the stationary support base and the other end connected to the displaceable support member.

In accordance with an aspect of the present invention, there is provided a retractable trailer stand assembly for supporting a trailer, the assembly comprising: (a) a support base for mounting atop or at least partially under a surface; and (b) one or more extendable support members attached to the support base and moveable between a first position and a second supporting position for supporting the trailer by contact with an underside of the trailer.

In an embodiment, the assembly further comprises a moving mechanism associated with each of the one or more support members for moving the one or more support members between the first and second positions.

In an embodiment, each of said moving mechanism comprises a first moving mechanism and a second moving mechanism.

In an embodiment, each of the one or more extendable support members comprises a base structure and at least one slidably attached raisable structure.

In an embodiment, each of said at least one slidably attached raisable structure is slidably attached to a respective said base structure or another of said at least one slidably attached raisable structure in adjacent relation.

In an embodiment, each of the one or more extendable support members comprises the base structure and one of the at least one slidably attached raisable structure.

In an embodiment, each of said first moving mechanism is attached at one end thereof to the support base and at another end thereof to a respective said base structure, and wherein each said second moving mechanism is attached at one end thereof to the respective said base structure and at another end thereof to a contacting end of a respective said one of the at least one slidably attached raisable structure.

In an embodiment, the respective base structure and slidably attached raisable structure is in a storage position when the respective one of said one or more extendable support members is in the first position, and wherein the respective base structure and slidably attached raisable structure is in an upright position when the respective one of said one or more extendable support members is moved out of the first position by the first moving mechanism, each said first moving mechanism for moving each said base structure and slidably attached raisable structure from the storage position to the upright position, and each said second moving mechanism for slidably raising each said raisable structure until each said raisable structure contacts the underside of the trailer such that each of said one or more extendable support members is in the second position.

In an embodiment, each of said raisable structure is in a position that is substantially adjacent each said respective base structure when the respective one of said one or more extendable support members is in the first position, and wherein each said raisable structure is at least partially raised out of the substantially adjacent position when the respective one of said one or more extendable support members is in the second position.

In an embodiment, each of said contacting end comprises a contacting surface for contacting said underside of the trailer when each said one or more extendable support members is in the second position, each said second moving mechanism being attached at said another end thereof to a side of the contacting end that is opposite the contacting surface.

In an embodiment, each of said first moving mechanism comprises a first hydraulic cylinder and wherein each said second moving mechanism comprises a second hydraulic cylinder.

In an embodiment, each of said first hydraulic cylinder is pivotally attached at said one end thereof to the support base and pivotally attached at said another end thereof to the respective said base structure.

In an embodiment, the assembly further comprises an upper surface when each said base structure is in the storage position, and an outer cover attached to each said base structure, the upper surface comprising each said outer cover.

In an embodiment, the assembly further comprises at least front, rear, right, and left side walls removably attached between the support base and the upper surface with bottom ends of the at least front, rear, right, and left side walls abutting outer edges of the support base and top ends of the at least front, rear, right, and left side walls abutting outer edges of the upper surface, at least the support base, the front, rear, right, and left side walls, and the upper surface forming an enclosure for receiving each of said one or more extendable support members and each of said first and second moving mechanisms when each of the one or more extendable support members is in the first position.

In an embodiment, each of the support base and the upper surface has a substantially quadrilateral shape, and wherein the support base has a longer length and a longer width than the length and width of the upper surface such that each of the at least front, rear, right, and left side walls forms a ramp.

In an embodiment, the support base and the upper surface have substantially the same shape with substantially the same dimensions.

In an embodiment, each said shape of the support base and the upper surface is substantially a quadrilateral.

In an embodiment, each said shape of the support base and the upper surface is substantially a square or a rectangle.

In an embodiment, each said shape of the support base and the upper surface is substantially a square or a rectangle.

In an embodiment, the assembly further comprises a plurality of support structures that, in the first position of the assembly, are positioned between the support base, and the ramps and the upper surface, to support the ramps and the upper surface.

In an embodiment, the assembly further comprises a plurality of support structures that, in the first position of the assembly, are positioned between the support base and the upper surface, to support the upper surface.

In an embodiment, each of the one or more extendable support members is pivotally attached to the support base generally under opposite sides of the upper surface such that when the one or more extendable support members are in the first position, the contacting surfaces are in close adjacent relation to one another.

In an embodiment, actuation of each said first hydraulic cylinder causes each said base structure to pivot about said pivotal attachment of each of the one or more extendable support members to the support base so that the one or more extendable support members pivot away from one another until each said base structures and slidably attached raisable structure is in the upright position.

In an embodiment, actuation of each said second hydraulic cylinder once each said base structure and slidably attached raisable structure is in the upright position causes each said raisable structure to slidably raise until each said contacting surface of each said raisable structure contacts the underside of the trailer such that each of said one or more extendable support members is in the second position.

In an embodiment, the moving mechanism is powered and controllable by a remote power source and control device electrically connected to the assembly by wired connection.

In an embodiment, the first hydraulic cylinder and the second hydraulic cylinder receive hydraulic fluid under pressure from and return hydraulic fluid to a remotely located hydraulic assembly via hydraulic fluid lines.

In an embodiment, the wired connection and the hydraulic fluid lines are enclosed within a conduit mounted atop or at least partially under the surface.

In an embodiment, the assembly further comprises an electrical junction box and at least one removably attached access panel for access to the electrical junction box.

In an embodiment, the assembly comprising two of said at least one removably attached access panel, the assembly further comprising a hydraulic junction assembly, a second of said at least one removably attached access panel for access to the hydraulic junction assembly.

In an embodiment, the support base, the upper surface, and the at least front, rear, right, and left side walls are comprised of a thermally conductive metal.

In an embodiment, the assembly further comprises a temperature sensor and at least one heating pad attached to the support base and positioned between the support base and the one or more extendable support members when in the first position, the temperature sensor communicatively coupled to the at least one heating pad and causing the at least one heating pad to activate when the temperature sensor detects that an ambient temperature is at or below a threshold temperature.

In an embodiment, the threshold temperature is 0° Celsius.

In an embodiment, the at least front, rear, right, and/or left side walls has formed therein at least one cut-out, each said cut-out for drainage of meltwater from an interior of the assembly to an exterior of the assembly.

In an embodiment, the assembly further comprises an illuminating mechanism on an interior of the assembly, wherein the at least front, rear, right, and/or left side walls, and/or the upper surface, have apertures formed therein such that illumination of the illuminating mechanism is visually perceivable by persons exterior to the assembly.

In an aspect of the present invention, there is provided a collapsible trailer safety stand to be located adjacent the kingpin of an unfettered trailer, the kingpin being normally engaged by the tractor of the vehicle, the collapsible trailer safety stand comprising: a stationary base having first and second ends; the base having pivotally attached thereto at least one stabilizing arm, the at least one stabilizing arm having a proximal end pivotally attached to the base, and a distal end, the at least one stabilizing arm having, at its distal end, a support, the at least one stabilizing arm being moveable from a first position wherein the at least one stabilizing support is disposed substantially flat within the base so as not to interfere with the movement of the trailer, to a second position wherein the support is disposed adjacent the kingpin, the at least one stabilizing arm being engaged with a drive, which drives the at least one stabilizing arm to move the at least one stabilizing arm from the first position to the second position locating the support adjacent to the kingpin of the trailer, whereby the collapsible safety stand when in the second position prevents nose diving of the trailer when the trailer is being loaded or unloaded.

In an embodiment of the present invention, the at least one stabilizing arm comprises a sensor in communication with the drive to sense when the at least one stabilizing arm is adjacent the nose of the unfettered trailer to locate the at least one stabilizing arm at a position consistent with the height of the trailer such that when the at least one stabilizing arm moves, it will be in the correct second position.

In an embodiment, when the at least one stabilizing arm is in the second position the at least one stabilizing arm is disposed at an angle greater than ninety degrees from the first position.

In an embodiment, the at least one stabilizing arm comprises an engagement portion for engaging the base to lock the at least one stabilizing arm in the second position and to prevent the at least one stabilizing arm from moving relative to the base.

In an embodiment, the drive is at least one cylinder pivotally connected at one end thereof to the base at and at the other end of, to the at least one stabilizing arm.

In an embodiment, the at least one stabilizing arm comprises means for locking the at least one stabilizing arm at any number of stop positions when being moved between the first and second positions.

In an embodiment, the drive is at least one cylinder comprising a first end pivoted to the base and the means for locking comprises a portion of the proximal end of the at least one stabilizing arm, which proximal end will not interfere with the motion of the at least one stabilizing arm when the at least one stabilizing arm is in the first position but which engages the base when the at least one stabilizing arm moves to the second position.

In an embodiment, the at least one stabilizing arm maintains the support substantially vertical when the at least one stabilizing arm is in the first position and maintains the support substantially horizontal when the at least one stabilizing arm is in the second position.

In accordance with an aspect of the present invention, there is provided a collapsible trailer safety stand comprising: a stationary base having first and second ends; the base having pivotally attached thereto at least one stabilizing arm, the at least one stabilizing arm having a proximal end pivotally attached to the base, and a distal end, the at least one stabilizing arm having at its distal end, a support, the at least one stabilizing arm being moveable from a first position wherein the at least one stabilizing arm is disposed substantially flat against the base, to a second position wherein the at least one stabilizing arm is disposed a vertical distance from the base, the at least one stabilizing arm being engaged with a drive, which drives the at least one stabilizing arm to move the at least one stabilizing arm from the first position to the second position, whereby the at least one stabilizing arm when in the second position may be used as a trailer safety stand.

In an embodiment, the stand comprises a sensor in communication with the drive to sense when the at least on stabilizing arm is adjacent the predetermined position to locate the sled thereat such that when the support moves it will be in the correct second position.

In an embodiment, the stand comprises a means for locking the at least one stabilizing arm at the stop positions when the at least one stabilizing arm is moved to the second position.

In an embodiment, the drive is at least one cylinder including a first end pivoted to the base, the means for locking comprising a portion extending from the proximal end of the at least one stabilizing arm, and which will not interfere with the motion of the at least one stabilizing arm when the at least one stabilizing arm is in the first position but which engages the base when the at least one stabilizing arm moves to the second position.

In accordance with an aspect of the present invention, there is provided a collapsible trailer safety stand for engaging an unfettered trailer adjacent the kingpin thereof, the kingpin being disposed adjacent the nose of the trailer, the safety stand comprising: a base having first and second ends, a supporting assembly carried on the base and movable relative to the base between a collapsed, stored position, wherein the supporting assembly is disposed substantially flat towards the base, and a raised, supporting position, in which a portion of the supporting assembly is disposed vertically above the base to engage and support the trailer adjacent the kingpin thereof, a sensor for sensing the position of the supporting assembly, the sensor being operatively connected to the base and the supporting assembly such that the sensor senses the supporting assembly in the stored position and senses the supporting assembly as it moves relative to the base from the collapsed, stored position to the supporting position such that the supporting assembly is properly positioned adjacent the kingpin of the trailer to support the front nose of the trailer when the supporting assembly is in the supporting position.

In an embodiment, the supporting assembly comprises: at least one stabilizing arm having a first end pivotally attached to the base, and a second end, a support, the support being attached to the at least one stabilizing arm at the second end thereof, the support engaging and supporting the trailer adjacent the kingpin when the supporting assembly is in the supporting position, a drive pivotally connected to the base and operatively connected to the at least one stabilizing arm to drive the at least one stabilizing arm to move the support into engagement and support of the trailer adjacent the kingpin when the supporting assembly is in the supporting position.

In an embodiment, the drive is operatively connected to a sensor such that the drive moves the support into engagement and support of the nose of the trailer adjacent the kingpin upon the sensor sensing engagement of the support with the nose of the trailer.

In an embodiment, the collapsible trailer safety stand comprises a locking mechanism for alternately locking the supporting assembly in the stored and supporting positions.

In accordance with an aspect of the present invention, there is provided a collapsible trailer safety stand comprising: a base locatable adjacent the front of a loading bay a predetermined distance away from a dock so as to be located adjacent the kingpin of an unfettered trailer, the kingpin normally engaged by a tractor and the unfettered trailer being positioned in the loading bay adjacent to the dock when the trailer is disconnected from the tractor, the collapsible safety stand comprising a top and bottom and having located, proximate its bottom, the base having pivotally attached thereto at least one stabilizing arm, said at least one stabilizing arm comprising a support disposed proximate the end of said at least one stabilizing arm remote the base, the at least one stabilizing arm being moveable from a first position wherein the at least one stabilizing arm is disposed substantially adjacent the base whereat the safety stand lays substantially flat in the loading bay so as not to interfere with the movement of a tractor trailer when decoupling the trailer, to a second position wherein the support of the at least one stabilizing arm is disposed adjacent the kingpin.

In an embodiment, the at least one stabilizing arm stabilizes the trailer in a stabilized position.

In an embodiment, the at least one stabilizing arm is disposed at an angle greater than ninety degrees from the first position, and engages against the underside of the nose portion of the trailer with a force sufficient to prevent motion of the trailer, to substantially lock the trailer substantially in the dock of the loading bay when the trailer is docked.

In an embodiment, the at least one stabilizing arm is engaged with a drive to drive said at least one stabilizing arm from the first position to the second position locating the mechanism adjacent to said kingpin of said tractor trailer, whereby the collapsible safety stand prevents nose diving of the trailer when the trailer is being loaded or unloaded by conventional means.

In an embodiment, the drive is a hydraulic cylinder, a pneumatic cylinder or a mechanical/electric drive.

In accordance with another aspect of the present invention, there is provided a collapsible trailer safety stand to be located adjacent the kingpin of an unfettered trailer, the collapsible trailer safety stand comprising: a stationary base having two ends; the base having pivotally attached thereto at least one stabilizing arm, said at least one stabilizing arm having attached therewith a support, disposed proximate the end of said at least one stabilizing arm remote said base, the at least one stabilizing arm being moveable from a first position wherein the at least one stabilizing arm is disposed substantially parallel with said base, whereat the at least one stabilizing arm lays substantially flat so as not to interfere with the movement of a tractor trailer when decoupling the trailer, to a second position wherein the support is disposed adjacent the kingpin.

In an embodiment, the at least one stabilizing arm is disposed at an angle greater than ninety degrees from the first position, and engages against the underside of the nose portion of the trailer with a force sufficient to prevent the motion of the trailer to lock the trailer substantially in the dock of the loading bay when the trailer is docked.

In an embodiment, the at least one stabilizing arm is engaged with a drive to drive said support from the first position to the second position locating the support adjacent to said kingpin of said tractor trailer.

In an embodiment, the drive is a hydraulic cylinder, a pneumatic cylinder or a mechanical/electrical drive.

In an embodiment, the stand comprises a sensor in communication with the drive to sense when the at least one stabilizing arm is in the first stored position is adjacent the base and when the at least one stabilizing arm is in the second supporting position adjacent the nose of the unfettered trailer to locate the at least one stabilizing arm at a trailer engaging position.

In an embodiment, the drive for the at least one stabilizing arm comprises means for locking the at least one stabilizing arm at the multiplicity of stop positions from the first stored position to the second supporting position when the at least one stabilizing arm is moved to the second position.

In an embodiment, the at least one stabilizing arm has a portion remote the support which will not interfere with the motion of the at least one stabilizing arm when the at least one stabilizing arm is in the first position but which engages a predetermined portion of the base when the at least one stabilizing arm moves to the second position, whereby the collapsible safety stand when in the second position prevents nose diving of the trailer when the trailer is being loaded by conventional means.

In accordance with an aspect of the present invention, there is provided a collapsible safety stand comprising: a stationary base having two ends; the base having pivotally attached thereto at least one stabilizing arm, said at least one stabilizing arm having attached therewith a support disposed proximate the end of said at least one stabilizing arm remote said base and being moveable from a first position wherein the at least one stabilizing arm is disposed substantially parallel to said base, whereat the at least one stabilizing arm lays substantially flat adjacent the base, to a second position wherein the support is disposed a vertical distance from the base, whereat said at least one stabilizing arm is disposed at an angle greater than ninety degrees from the first position when laying flat adjacent the base, the at least one stabilizing arm being engaged with a drive to drive said support from the first position to the second position.

In an embodiment, the stand has a sensor in communication with the drive to sense when the at least one stabilizing arm is in the first stored position and in the second supporting position.

In an embodiment, the drive for the at least one stabilizing arm comprises means for locking the at least one stabilizing arm at a multiplicity of stop positions when the support is moved to the second position.

In an embodiment, the drive is a hydraulic cylinder, a pneumatic cylinder or a mechanical/electrical drive.

In an embodiment, the proximal end of the at least one stabilizing arm remote the support, will not interfere with the motion of the at least one stabilizing arm when the at least one stabilizing arm is in the first position but which engages a predetermined portion of the base at the second position when the support moves to the second position, whereby the stand when in the second position may be used as a trailer support safety stand.

In accordance with another aspect of the present invention there is provided, a collapsible trailer support safety stand comprising a top and bottom and having located proximate its bottom a base having pivotally attached thereto at least one stabilizing arm, said at least one stabilizing arm having attached therewith a support disposed proximate the end of said at least one stabilizing arm remote said base and being moveable from a first position wherein the at least one stabilizing arm is disposed substantially parallel to the base whereat the stand lays substantially flat, to a second position wherein the at least one stabilizing arm is disposed a vertical distance from the base, whereat said at least one stabilizing arm is disposed at an angle greater than ninety degrees from the first position when laying flat adjacent base, the at least one stabilizing arm being engaged with a drive to drive said support from the first position to the second position whereby the stand when in the second position may be used as a trailer support safety stand.

In an embodiment, the at least one stabilizing arm maintains the support substantially vertical when the at least one stabilizing arm is in the first position and substantially horizontal when the at least one stabilizing arm is in the second position.

In accordance with another aspect of the present invention, there is provided a method for supporting the nose of an unfettered trailer disposed on a surface adjacent a loading bay, comprising the steps of: providing a supporting assembly movable between a stored, collapsed position wherein the supporting assembly does not interfere with movement of vehicles over the surface, and a raised, engaging position in which a portion of the supporting assembly is disposed vertically above the surface and engages and supports the nose of the trailer; and moving the supporting assembly from the stored position to the raised engaging position to support the nose of the trailer.

In an embodiment, the method further comprises the step of locking the supporting assembly in the supporting position to prevent the supporting assembly from moving relative to the base while in the raised, engaging position.

Other aspects and advantages of the present invention will become apparent to persons skilled in this art from the following description with reference to the Figures.

### BRIEF DESCRIPTION OF THE DRAWINGS

The present invention will be further understood from the following description with reference to the Figures, in which:

FIG. 1 is an isometric view of the trailer stand assembly of the present invention in the lowered stored position;

FIG. 2 is an isometric view of the trailer stand assembly of the present invention in the raised operable position;

FIG. 3 is an isometric view of the base of the trailer stand assembly of the present invention;

FIG. 4 is a right side view of the trailer stand assembly of the present invention in the lowered stored position mounted to the driveway in front of a loading dock relative to a trailer parked at the loading dock;

FIG. 5 is an isometric view of a moveable support member assembly of the trailer stand assembly of the present invention in the raised operable position;

FIG. 6 is an isometric view of a moveable support member of the trailer stand assembly of the present invention in the raised operable position;

FIG. 7 is a left-end view of a moveable support member of the trailer stand assembly of the present invention in the raised operable position;

FIG. 8 is an exploded perspective view of a pivot assembly of the trailer stand assembly of the present invention;

FIG. 9 is a rear view of the trailer stand assembly of the present invention in the raised operable position;

FIG. 10 is a perspective view of a moving mechanism of the trailer stand assembly of the present invention in the raised operable position;

FIG. 11 is a perspective view of the centre bridge supports and terminal box of the trailer stand assembly of the present invention;

FIG. 12 is a top view of the centre bridge supports and terminal box of the trailer stand assembly of the present invention;

FIG. 13 is a top perspective view of the trailer stand assembly of the present invention in the raised operable position without the top frame, the front and rear ramps and the left and right side ramps;

FIG. 14 is a perspective view of the trailer stand assembly of the present invention in the lowered closed position with an above-surface electrical conduit tray running between the assembly and the loading dock;

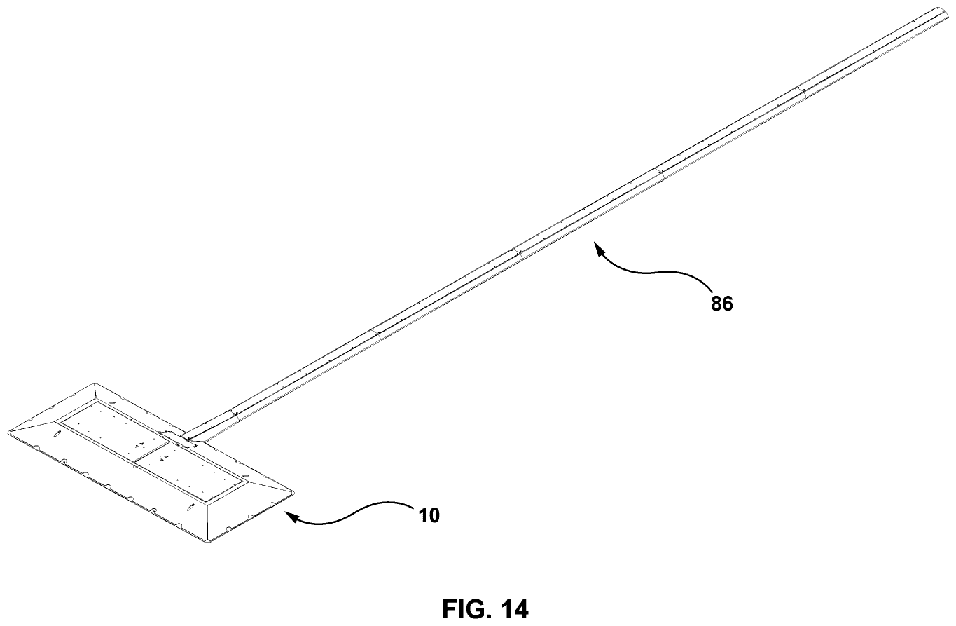

FIG. 15 is a front view of a control device of the trailer stand assembly of the present invention;

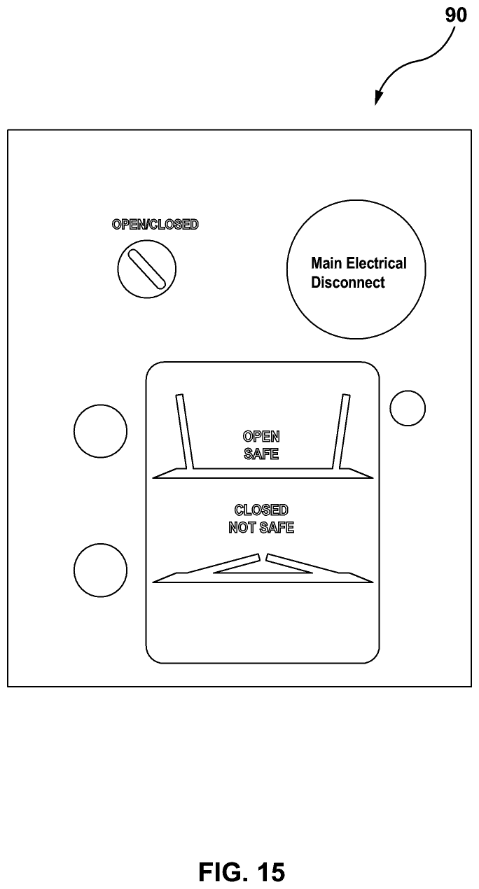

FIG. 16 is a front view of another embodiment of the trailer stand assembly of the present invention showing extendable support members raised partway to the upright position;

FIG. 17 is a front view of the embodiment of the trailer stand assembly shown in FIG. 16 with extendable support members in an upright position;

FIG. 18 is a front view of the embodiment of the trailer stand assembly shown in FIG. 16 with extendable support members in a second supporting position;

FIG. 19 is a right side view of the embodiment of the trailer stand assembly shown in FIG. 16 with extendable support members in a second supporting position and in contact with the underside of a trailer;

FIG. 20 is a rear isometric view of the embodiment of the trailer stand assembly shown in FIG. 16 with extendable support members in a second supporting position;

FIG. 21 is a top rear isometric view of the embodiment of the trailer stand assembly shown in FIG. 16 with extendable support members in a second supporting position and with the rear side walls, rear access panel, and portions of the left base structure and the left raisable structure removed;

FIG. 22 is a top front isometric view of the embodiment of the trailer stand assembly shown in FIG. 16 with extendable support members in a second supporting position and with a front side wall, front access panel, and portions of the left base structure and the left raisable structure removed;

FIG. 23 is a bottom front isometric view of the embodiment of the trailer stand assembly shown in FIG. 16 with extendable support members in a second supporting position;

FIG. 24 is a front view of the embodiment of the trailer stand assembly shown in FIG. 16 mounted at least partially under a surface and with extendable support members in a second supporting position;

FIG. 25 is a top view of the embodiment of the trailer stand assembly shown in FIG. 16 with extendable support members in a first position and without the conduit;

FIG. 26 is a right side view of the embodiment of the trailer stand assembly shown in FIG. 16 with extendable support members in a first position and showing a control device and hydraulic assembly remotely located from the trailer stand assembly;

FIG. 27 is a partial front view of another embodiment of a control device; and

FIG. 28 is a top isometric partial view of another embodiment of a conduit.

### PARTS LIST OF THE INVENTION

10 trailer stand assembly
12 surface
14 base
15 mounting aperture of base
16 moveable support member assembly
18 moveable support member
20 pivot assembly
22 inner frame
24 outer cover
25 aperture of outer cover
26 top member of inner frame
28 side member of inner frame
30 end cap of top member
32 gusset of moveable support member
33 bottom brace of moveable support member
34 support for bottom brace
36 pivot bracket
38 bore for pivot shaft
40 pivot shaft
41 cotter pin for pivot shaft
42 wedge block for side member
44 mid support for side member
46 holder for cable/wire
48 moving mechanism
50 top mount for moving mechanism
52 locating rib for top mount
56 bottom mount for moving mechanism
58 limit switch
60 top support for side member
62 heating mechanism
64 temperature sensor
66 mount for temperature sensor
68 terminal block
70 aperture in base for electrical wires
72 housing assembly
74 top frame
75 front and rear ramps
76 gussets for front and rear ramps
77 left and right side ramps
78 gussets for left and right side ramps
79 gussets for conduit
80 illuminating mechanism
82 aperture for terminal block in rear ramp
83 conduit aperture in rear ramp
84 access cover for aperture for terminal block
85 plate cover for conduit aperture
86 electrical conduit tray
87 cut-outs for ramps
88 apertures for ramp assembly
89 support frame for access cover
90 control device
100 another embodiment of trailer stand assembly
102 trailer
104 support base
106 upper surface
108 extendable support members
110 underside of trailer
112 trailer landing gear
114 moving mechanism
114a first moving mechanism
114b second moving mechanism
116 base structure
118 raisable structure
120 one end of first moving mechanism (connected to support base)
122 connecting structure
124 another end of first moving mechanism (connected to support base)
126 one end of second moving mechanism (connected to base structure)
128 another end of second moving mechanism (connected to contacting end)
130 contacting end of raisable structure
132 contacting surface of contacting end of raisable structure
134 side of contacting end that is opposite the contacting surface
136 first hydraulic cylinder
138 second hydraulic cylinder
140 pivot assembly (connecting base structure to support base)
142 outer cover (attached to each base structure)
144 top frame
146 front, rear, right, and left side walls
148 bottom ends of side walls
150 outer edges of support base
152 top ends of side walls
154 outer edges of upper surface
156 enclosure
158 ramp
160 conduit
162 rear (hydraulic) access panel
164 support structures
166 gussets
168 base structure frame
170 control device
170a main disconnect
170b open or engage button
170c close or disengage button
170d fault reset button
170e warning buzzer light
170f e-stop button
172 hydraulic assembly
174 conduit side walls
176 upper conduit surface
178 lower conduit surface
180 conduit ramp
182 front (electrical junction box) access panel
184 bolted connection
186 electrical junction box
188 hydraulic junction assembly
190 temperature sensor and switch
192 heating pad
194 cut-out
196 illuminating mechanism
198 apertures in gussets
200 apertures for light to be visible outside
202 warning buzzer or beeper
204 limit switch
206 hydraulic diverter valve
208 counterbalance valve
210 conduit support structure

### DETAILED DESCRIPTION OF CERTAIN ASPECTS OF THE INVENTION

Referring now to the drawings and the illustrative embodiments depicted therein, there is shown a retractable trailer stand assembly 10 of the present invention for mounting to a surface 12, for example, to the driveway in front of a loading dock.

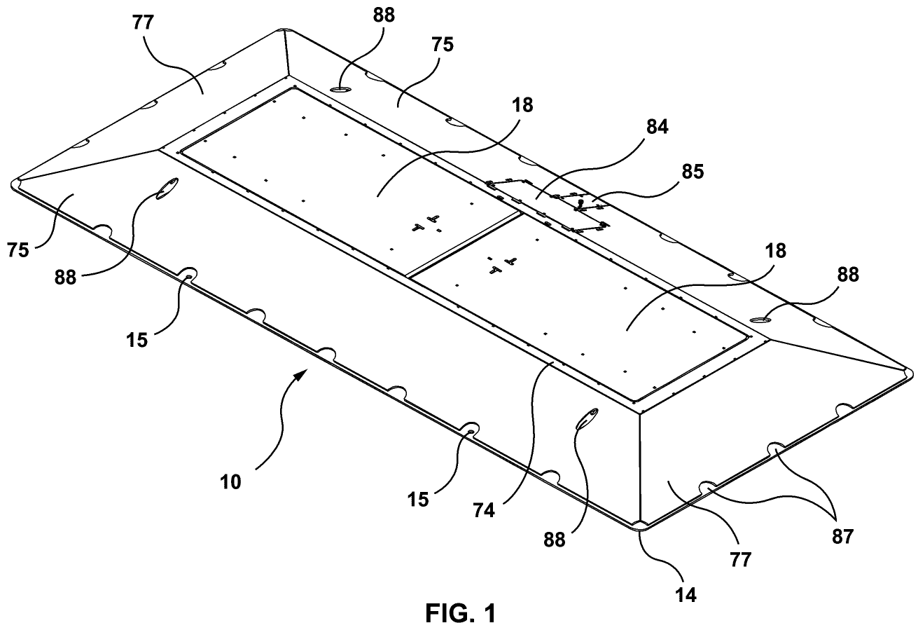

FIG. 1 generally illustrates the surface-mountable retractable trailer stand assembly 10 of the present invention in a lowered, retracted, closed or stored position, wherein the trailer stand assembly 10 is capable of permitting, for example, a trailer to be driven thereover.

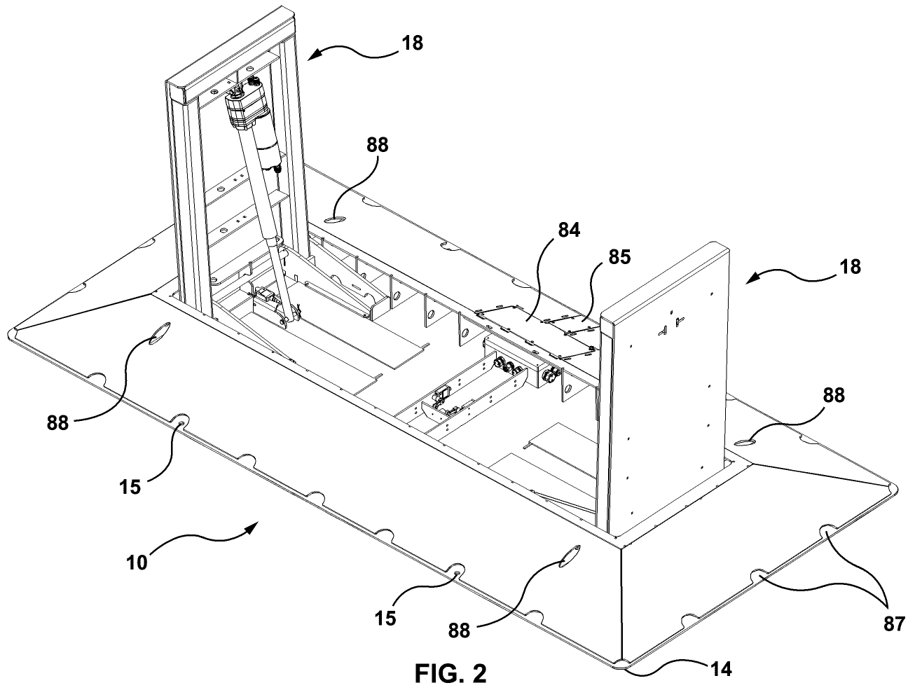

FIG. 2 generally illustrates the surface-mountable retractable trailer stand assembly 10 of the present invention in a raised, extended, open or operable position, wherein the trailer stand assembly 10 is capable of supporting a trailer if and when its landing gear fails or collapses and thus is capable of preventing such a trailer from tipping over or nose diving.

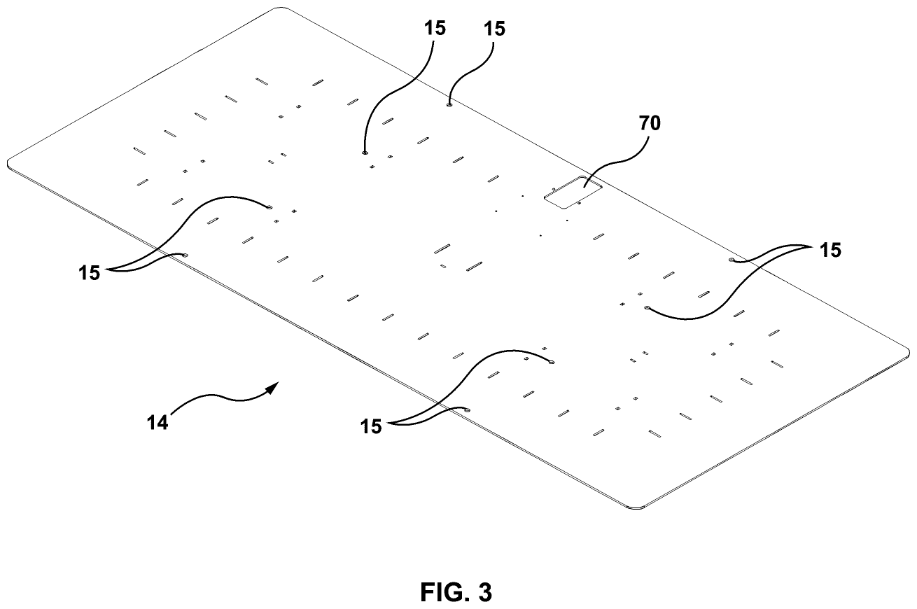

Referring now to FIG. 3, in an embodiment of the present invention, the trailer stand assembly 10 comprises a base 14 for mounting to a surface 12, for example the driveway in front of a loading dock, the base 14 having a front end, a rear end, a left end, a right end, a lower surface for abutting the surface 12 for mounting thereto, and an upper surface for mounting the various components of the trailer stand assembly 10 thereto. In an embodiment, the base 14 is a flat plate. In an embodiment, the base 14 has a rectangular shape. In an embodiment, the base 14 having a rectangular shape may have the dimensions of, for example, but not limited to, about 115 inches to about 120 inches wide by about 55 inches to about 60 inches deep. In an embodiment, the base 14 having a rectangular shape may have the dimensions of, for example, but not limited to, about 118.50 inches wide by about 57.50 inches deep. It will however be understood that other dimensions would be available for the base 14 having a rectangular shape within the range of the present invention. It will also be understood that the base 14 could be in the form of any shape and dimension, including square, circular, triangular or the like, as would be understood by persons skilled in this art. In an embodiment, the base 14 may be a flat metal plate, for example, but not limited to, ¼ inch flat steel plate. In an embodiment, the base 14 may comprise apertures 15 formed therein for mounting to the surface 12, such as the concrete or asphalt driveway in front of a loading dock, via fasteners, for example, but not limited to, lag bolts or anchors. In an embodiment, the base 14 may comprise eight preformed apertures 15 for mounting to the surface 12, four apertures 15 proximate each of the left and right ends thereof, horizontally spaced apart spanning the distance between the front and rear ends thereof, for mounting to the surface 12. However, as would be understood by persons skilled in this art, the base 14 may comprise fewer or greater number of preformed apertures 15 for mounting to the surface 12.

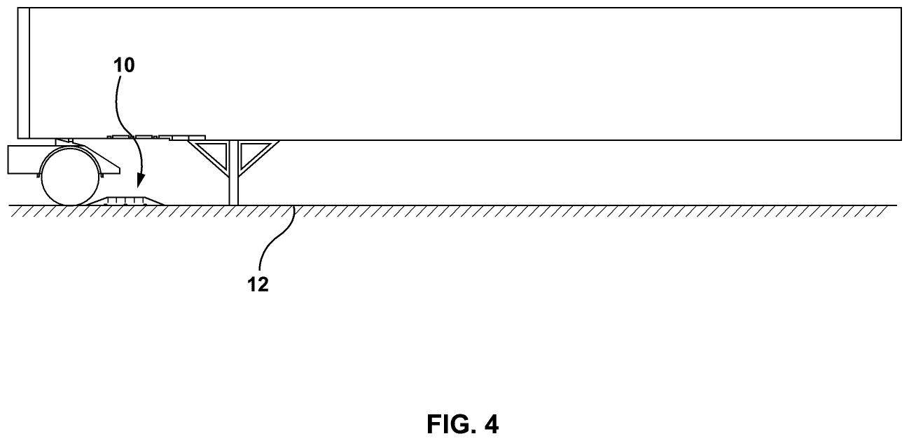

Trailers typically come in a few standard lengths, for example, but not limited to, 53, 48 and 45 foot lengths. The end user will mount the trailer stand assembly 10 to, for example, the driveway in front of a given loading dock at their facility at the appropriate distance from the loading dock according to the length of the trailers which typically park at that loading dock. Proper mounting of the trailer stand assembly 10 to the driveway in front of the loading dock will be just behind the rear wheels of the tractor parking the trailer at the loading dock and just in front of the landing gear, or the gussets of the landing gear, of the trailer, as shown in FIG. 4. Mounting of the trailer stand assembly 10 at this position on the driveway in front of the loading dock, will ensure that when the trailer is parked at the loading dock and the trailer stand assembly 10 is raised to its operable position, and if the landing gear of the trailer fails or collapses, the trailer will engage the trailer stand assembly 10 and will be prevented from tipping over or nose diving. In addition, mounting of the trailer stand assembly 10 at this position may ensure that if and when the trailer engages the trailer stand assembly 10, the trailer stand assembly 10 will be engaged by at least one of the multiple horizontally spaced apart support ribs on the underside of the trailer running across the entire width of the trailer.

In an embodiment, the trailer stand assembly 10 comprises one or more moveable or displaceable support members 18 capable of being moved between a first lowered, retracted, closed or stored position, wherein the one or more moveable support members 18 are substantially horizontally oriented and thus are substantially parallel to the base 14 and thus the surface 12 (when mounted), and a second, raised, extended, open or operable position, wherein the one or more moveable support members 18 are substantially vertically oriented and thus are substantially orthogonal to the base 14 and thus the surface 12 (when mounted). The terms “first”, “lowered”, “retracted”, “closed” or “stored”, as used herein to describe the orientation of the one or more moveable support members 18, i.e., substantially horizontally oriented and thus substantially parallel to the base 14 and thus the surface 12 (when mounted), are used interchangeably. The terms “second”, “raised”, “extended”, “open” or “operable”, as used herein to describe the orientation of the one or more moveable support members 18, i.e., substantially vertically oriented and thus substantially orthogonal to the base 14 and thus the surface 12 (when mounted), are used interchangeably. The term “substantially horizontally” and “substantially parallel”, as used herein mean from about −5 degrees to about +5 degrees relative to horizontal. The terms “substantially vertically” and “substantially orthogonal”, as used herein mean from about −5 degrees to about +5 degrees relative to vertical.

When the one or more moveable support members 18 are in the lowered stored position, the trailer stand assembly 10 is capable of permitting, for example, a trailer to be driven thereover. When the one or more support members 18 are in the raised operable position, the trailer stand assembly 10 is capable of supporting a trailer if and when its landing gear fails or collapses and thus capable of preventing such a trailer from tipping over or nose diving.

In an embodiment, the trailer stand assembly 10 comprises a pair of moveable support member assemblies 16, a left moveable support member assembly and a right moveable support member assembly, disposed in a horizontally spaced-apart relationship on the base 14, the left moveable support member assembly disposed proximate the left end of the base 14 and the right moveable support member assembly disposed proximate the right end of the base 14. However, the trailer stand assembly 10 may comprise any number of moveable support member assemblies 16, as would be understood by persons skilled in this art.

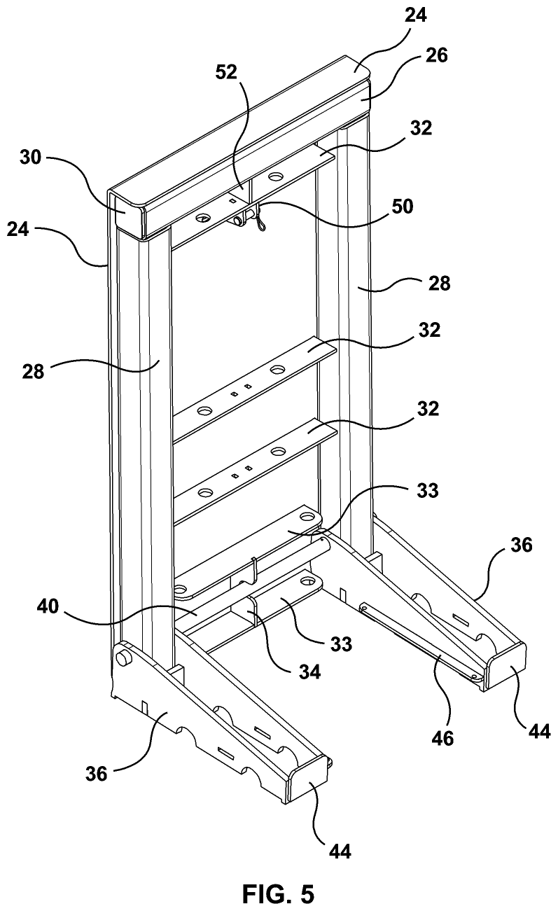

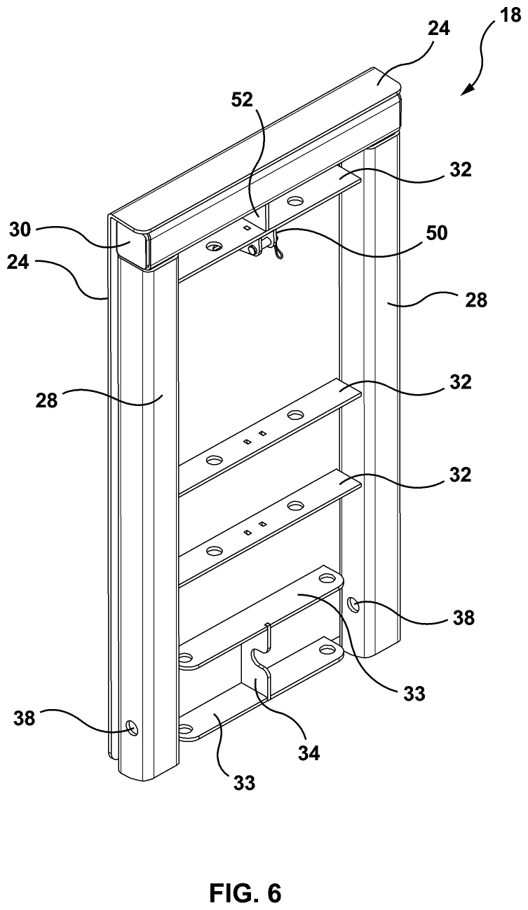

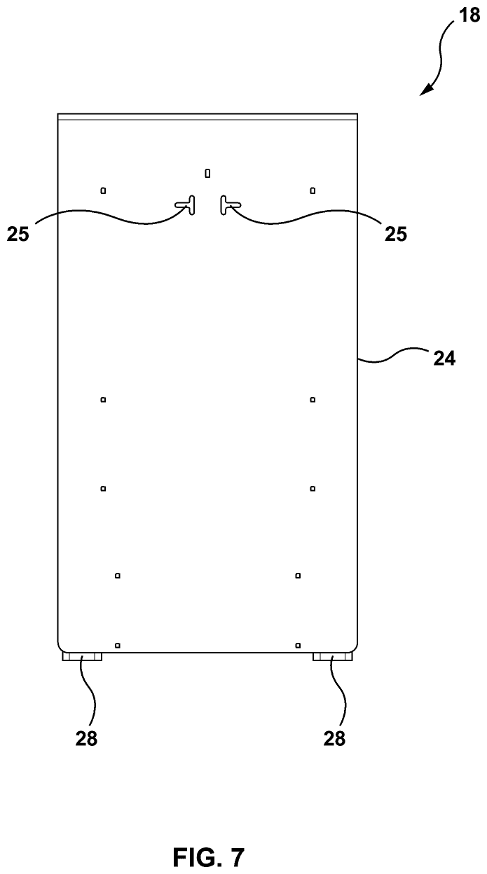

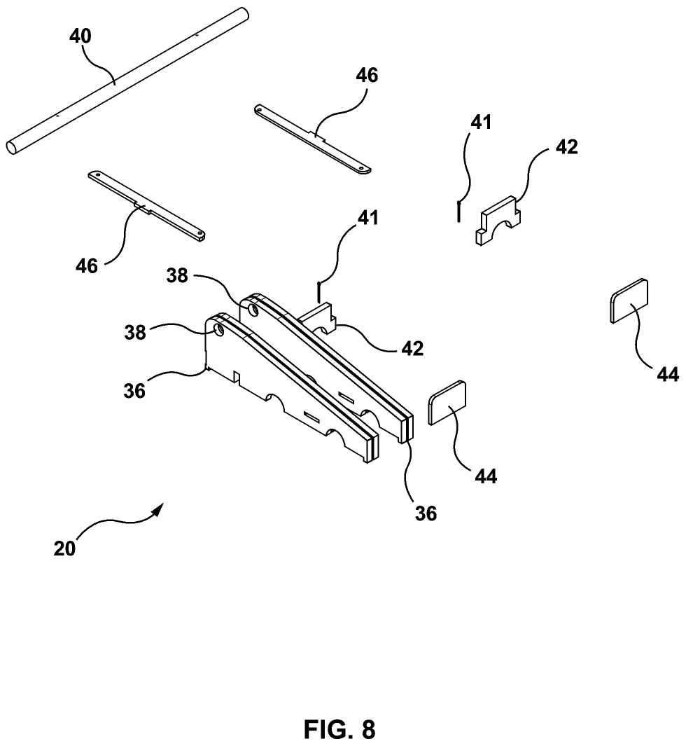

In an embodiment, each moveable support member assembly 16 (as shown in FIG. 5) of the pair of moveable support member assemblies is identical. In an embodiment, the moveable support member assembly 16 comprises a moveable support member 18 (as shown in FIGS. 6 and 7) and a pivot assembly 20 (as shown in FIG. 8).

In an embodiment, each moveable support member 18 is identical and has a bottom end, a top end, a left side, a right side, an outer face and an inner face. The bottom end is adjustably and pivotably secured to the base 14 and the top end is a free end which, when the moveable support member 18 is raised to its operable position as shown in FIG. 2, is capable of supporting a trailer if and when its landing gear fails or collapses and thus capable of preventing such a trailer from tipping over or nose diving. The moveable support member 18 has sufficient length and width such that when it is raised to its operable position, it is tall enough and wide enough to be capable of supporting a trailer. When the moveable support member 18 is raised to its operable position underneath the nose portion of a trailer parked at a loading dock, the top free end of the moveable support member 18 is, for example, but not limited to, about 1 inch to about 2.5 inches or about 1.5 inches to about 2 inches, below the underside surface of the nose portion of the trailer.

In an embodiment, the moveable support member 18 has a generally rectangular cross-section. In an embodiment, the moveable support member 18 may be about 40 to about 45 inches in length and about 20 to about 25 inches in width. In another embodiment, the moveable support member 18 is about 43 inches in length and about 23 inches in width. In another embodiment, the moveable support member 18 is about 43.25 inches in length and about 23.50 inches in width. However, it will be understood that other dimensions for the moveable support member 18 would be available within the range of the present invention. It will also be understood that the moveable support member 18 may have any number of cross-sections such as square, circular, triangular or the like, as would be understood by persons skilled in this art to exhibit favourable strength and rigidity characteristics which resist bending and swaying when supporting a trailer.

In an embodiment, the left moveable support member 18 is disposed on the base 14 via its lower end proximate the left end of the base 14 and the right moveable support member 18 is disposed on the base 14 via its lower end proximate the right end of the base 14. The lower ends of the left and right moveable support members 18 are disposed on the base 14 at a horizontally spaced apart distance such that the distance between the two moveable support members 18, when raised to their operable positions, can be designed in accordance with the desired specifications. In an embodiment, the space provided between the two moveable support members 18, when raised to their operable positions, thereby defines the minimal distance between the two moveable support members 18 and the according minimal width or distance between the two sides of the trailer to be supported. In an embodiment, the lower ends of the left and right moveable support members 18 are disposed on the base 14 at a horizontally spaced apart distance such that when the moveable support members 14 are lowered to their stored positions, their top free ends nearly abut one another and when they are raised to their operable positions, the distance between their top free ends spans a sufficient width of the trailer such that they are capable of supporting a trailer. For example, a typical trailer is about 102 inches wide and in one embodiment, when such a trailer is parked at the loading dock and the moveable support members 18 are raised to their operable position underneath the nose portion of a trailer, the top free ends of the left and right moveable support members 18 are located about 6 to about 8 inches inward from the left and right sides of the trailer, respectively.

In an embodiment, the moveable support member 18 is generally comprised of suitable material with sufficient strength such that when, in the lowered stored position, it can accommodate the weight of a trailer being driven thereover, and in the raised operable position, it can support the weight of a fully loaded trailer, possibly with forklift and operator inside, that engages the moveable support member 18 when its landing gear fails or collapses, but is still light enough in weight such that it can be raised to its operable position, and lowered to its stored position, either manually or mechanically, in a controlled manner with relative ease.

In an embodiment, the moveable support member 18 comprises an inner frame 22 and an outer cover 24. The inner frame 22 has an inner surface and an outer surface and comprises a top member 26 and a pair of identical horizontally spaced-apart side members 28, a left side member and a right side member. Each of the left and right side members 28 has a bottom end that makes up at least a portion of the bottom end of the moveable support member 18 that is adjustably and pivotably secured to the base 14, and a top end that makes up at least a portion of the top end of the moveable support member 18 that is the free end. The side faces of the lower ends of each of the left and right side members 28 comprise a pivot shaft bore 38 for receiving a pivot shaft 40, as will be discussed in further detail below. The top member 26 has a left end and a right end and is disposed at the top end of the left and right side members 28, is perpendicular to the longitudinal direction of the left and right side members 28, and transverses the width between the left and right side members 28. In an embodiment, the pair of horizontally spaced-apart side members 28, together with the top member 26, form a substantially U-shaped inner frame 22.

In an embodiment, each of the left and right side members 28 and the top member 26 of the inner frame 22 are hollow tubular members with a substantially square cross-section, however, they may have any other shaped cross section that would be known by persons skilled in this art to have similar strength, rigidity and weight and that could perform a similar function. In an embodiment, the left and right ends of the hollow tubular top member 26 are covered by end caps 30 to prevent debris, snow, ice etc. from entering, and possibly building up within, the ends of the top member 26. In an embodiment, each of the left and right side members 28 and top member 26 are hollow tubular metal and the end caps 30 of the top member 26 are plate metal. In an embodiment, the left and right side members 28 and the top member 26 are 3 inch square hollow tubular aluminum with a ¼ inch wall thickness and the end caps 30 are ¼ inch plate aluminum. Constructing the inner frame 22 out of aluminum reduces its weight and thus the weight of the moveable support member 18 and may make it easier for the moveable support member 18 to be raised and lowered.

In an embodiment, the outer cover 24 is a flat plate that covers the outer surface of the inner frame 22. The outer cover 24 has a top end, a bottom end, a left side, a right side, an outer surface and an inner surface. The inner surface of the outer cover 24 is secured to the outer surface of the inner frame 22 by welding or the like. In an embodiment, the top end of the outer cover 24 wraps around and covers the top end of the top member 26 of the inner frame 22, i.e., the top free-end of the moveable support member 18. The size of the outer cover 24 is determined by the size of the inner frame 22 of the moveable support member 18. When the moveable support member 18 is in its lowered stored position, the outer cover 24 provides an effective cover for the trailer stand assembly 10 preventing debris, snow, ice etc. from entering its interior and providing a safe working environment allowing vehicles to drive over, and pedestrians to walk on, the moveable support member 18. In an embodiment, the outer cover 24 may have at least one aperture 25 therethrough (two apertures 25 are shown in FIG. 7) to allow access to a moving mechanism 48 if associated with the moveable support member 18 when it is in the lowered stored position, as will be discussed in further detail below. In an embodiment, the outer cover 24 is a flat metal plate. In an embodiment, the outer surface of the outer cover 24 is checkered to give some texture and traction thereto for example, for workers who may walk across the moveable support member 18 when it is in the lowered stored position. In an embodiment, the outer cover 24 is a ¼ inch flat aluminum plate. Constructing the outer cover 24 out of aluminum reduces its weight and thus the weight of the moveable support member 18 and may make it easier for the moveable support member 18 to be raised and lowered.

In an embodiment, the moveable support member 18 may comprise at least one moveable support member gusset 32 on the inner surface of the outer cover 24 to provide further strength and rigidity to the moveable support member 18. In an embodiment, the moveable support member 18 comprises three gussets 32 spaced-apart along its length. However, the moveable support member 18 may comprise a greater or fewer number of gussets 32 associated therewith, as would be understood by persons skilled in this art. In an embodiment, the gussets 32 span the entire width of the inner frame 26 between, and abut against, the side members 28 thereof.

In an embodiment, the moveable support member 18 may comprise at least one bottom brace 33 on the inner surface of the outer cover 24 at the bottom end of the moveable support member 18 to provide further strength and rigidity to the bottom end of moveable support member 18. In an embodiment, the moveable support member comprises a pair of spaced apart bottom braces 33, a first lower bottom brace, located proximate the bottom end of the moveable support member 18, and a second upper bottom brace spaced-apart from the first lower bottom brace along the length of the moveable support member 18. In an embodiment, the at least one bottom brace 33 is shorter in length than the at least one gusset 32 due to the area occupied by the pivot brackets 36, which will be described in further detail below. In an embodiment, the first lower and second upper bottom braces 33 are connected, proximate their centre points, by a vertically oriented bottom brace support 34. In an embodiment, the vertical bottom brace support 34 is substantially “C” shaped with the notch of the “C” for accommodating the pivot shaft 40, which will be discussed in further detail below.

In an embodiment, one of the moveable support member gussets 32 is located proximate the top end of the moveable support member 18 and provides a surface for mounting the top end of the moving mechanism 48 if associated with the moveable support member 18, as will be discussed in further detail below. In an embodiment, each of the at least one moveable support member gusset 32 and at least one bottom brace 33 is a flat metal plate, for example, but not limited to, ¼ inch flat aluminum plate. Constructing the at least one moveable support member gusset 32 and at least one bottom brace 33 out of aluminum reduces their weight and thus the weight of the moveable support member 18 and may make it easier for the moveable support member 18 to be raised and lowered. The at least one moveable support member gusset 32 and the at least one bottom brace 33 is fixedly secured in place, via its lower edge, to the inner surface of the outer cover 24 through welding or the like. The at least one moveable support member gusset 32 is also fixedly secured in place, via its respective ends, to the respective side members 28 of the inner frame 22, through welding or the like. In addition to welding, the at least one moveable support member gusset 32 and the at least one bottom brace 33 may also be keyed into the outer cover 24, as would be known to persons skilled in this art.

In an embodiment, the moveable support member 18 is adjustably and pivotably secured at the bottom end thereof to the base 14 via a pivot assembly 20. In an embodiment, the pivot assembly 20 comprises at least one pivot bracket 36 and a pivot shaft 40 for pivotably moving the moveable support member 18 between a lowered stored position and a raised operable position. As discussed above, the top end of the moveable support member 18 is a free end which, when the moveable support member 18 is raised to its operable position, is capable of supporting a trailer if and when its landing gear collapses and thus capable of preventing such a trailer from tipping over or nose diving.

In an embodiment, the pivot assembly 20 comprises a pair of horizontally spaced-apart pivot brackets 36, a left pivot bracket and a right pivot bracket. The left and right pivot brackets 36 engage the left and right side members 28 of the inner frame 22 of the moveable support member 18, respectively and thus, the pivot brackets 36 are horizontally spaced-apart a distance equal to the distance between the left and right side members 28 of the inner frame 22 of the moveable support member 18. Each pivot bracket 36 is identical having a front end, a rear end, a left side and a right side. In an embodiment, the pivot bracket 36 comprises a pair of horizontally spaced-apart pivot bracket side plates, a left pivot bracket side plate forming the left side of the pivot bracket 36 and a right pivot bracket side plate forming the right side of the pivot bracket 36. The horizontally spaced-apart pivot bracket side plates define a central gap or channel therebetween within which the bottom ends of the left and right side members 28 of the inner frame 22, respectively are received and nest. The width of the gap or channel, i.e., the distance between the left and right pivot bracket side plates, equals or slightly exceeds the width of the bottom end of the side member 28 such to permit the bottom end of the side member 28 to pivot freely within the pivot bracket 36.

In an embodiment, each pivot bracket side plate is identical and has a front end terminating in a front edge, a rear end terminating in a rear edge, a top terminating in a top edge, a bottom terminating in a bottom edge, an outer surface and an inner surface. The bottom edge of the pivot bracket side plate is in abutting relation with the base 14 to affect fixed securement thereto. In an embodiment, the top of the pivot bracket side plate slopes downward from the rear end toward the front end such that the rear end is higher than the front end. The transition from the top edge to the rear edge is substantially rounded and the transition from the top edge to the front edge is substantially square. A pivot shaft bore 38 for receiving the pivot shaft 40 is formed in the pivot bracket side plate proximate the transition from the top edge to the rear edge. In an embodiment, the pivot bracket side plate is a flat plate member. In an embodiment, the pivot bracket side plate is a flat metal plate member, for example, but not limited to, ¼ inch flat steel plate. In an embodiment, the pivot bracket side plate is fixedly secured at its lower edge to the upper surface of the base 14 through welding or the like. In addition to welding, the pivot bracket side plate may also be keyed into the base 14 as would be known to persons skilled in this art. In an embodiment, the pivot bracket side plate may comprise at least one cut-out along its lower edge to allow, for example, debris to be washed, or snow or ice to melt, out from between the side plates of the pivot bracket 36. Build up of debris, snow, ice etc. between the pivot side plates of the pivot brackets 36 may interfere with the pivoting of the side members 28 within the pivot brackets 36.

In an embodiment, the pivot bracket 36 may further comprise a wedge block 42 for the side member 28 (as seen in FIG. 8), when the moveable support member 18 is raised to its operable position, to prevent the side member 28, and thus the moveable support member 18, from pivoting any further past its operable position. In an embodiment, the wedge block 42 for the side member 28 is in the form of an interconnecting wall which interconnects the left and right sides of the pivot bracket 36 at a location proximate the rear end thereof, the distance between the rear end of the pivot bracket 36 to the location of the wedge block 42 being equal to, or slightly exceeding, the depth of the bottom end of the side member 28. In an embodiment, the wedge block 42 for the side member 28 is a flat plate member. In an embodiment, the wedge block 42 is a flat metal plate member, for example, but not limited to, ¼ inch steel plate. The wedge block 42 is fixedly secured in place at its respective ends to the left and right sides of the pivot bracket 36, through welding or the like. The wedge block 42 is engaged by the inner face of the bottom end of the side member 28 when the moveable support member 18 is raised to its operable position and acts as a stop to prevent any further pivoting movement of the side member 28 about the pivot shaft 40 and to prevent the moveable support member 18 from pivoting beyond its operable position, particularly when a downward force is exerted on the top end of the moveable support member 18, as would be the case when the moveable support member 18 is supporting a trailer whose landing gear has failed or collapsed. The wedge block 42 may comprise at least one cut-out therein along its lower edge to allow for example, debris to be washed, or snow or ice to melt, out from behind, or in front of, the wedge block 42.

In an embodiment, the trailer stand assembly 10 further comprises at least one support for the moveable support member 18, when the moveable support member 18 is in its lowered stored position, to support the weight of the moveable support member 18 and to act as a stop to prevent any further pivoting movement of the moveable support member 18 about the pivot shaft 40 beyond its lowered stored position, especially when personnel step on, or when a vehicle drives over, the moveable support member 18 when it is in its lowered stored position. In an embodiment, the at least one support for the moveable support member 18 is a pair of mid supports 44 for the side members 28 of the moveable support member 18, a left mid support for the left side member and a right mid support for the right side member, each mid support 44 in the form of an interconnecting wall which interconnects the left and right side plates of each pivot bracket 36 at the front end thereof. In an embodiment, the mid support 44 is a flat plate member. In an embodiment, the mid support 44 is a flat metal plate member, for example, but not limited to, ¼ inch steel plate. The mid support 44 is fixedly secured in place at its respective ends to the front edges of the left and right sides of the pivot bracket 36, through welding or the like. When the moveable support member 18 is lowered to its stored position, the inner surface of the side member 28, approximately midway along the length of the side member 28, and thus approximately the midpoint of the side member 28, may engage the mid support 44, especially when personnel step on, or when a vehicle drives over, the moveable support member 18.

In an embodiment, the trailer stand assembly 10 may further comprise a cable/wire holder 46 to run and secure within the trailer stand assembly 10, the cables/wires for the electrical components of the trailer stand assembly 10. In an embodiment, the cable/wire holder 46 is in the form of a flat member, such as, for example, but not limited to, a flat metal bar, that runs along the inner facing surfaces of the right and left pivot bracket side plates of the left and right pivot brackets 36, respectively. The cable/wire holder 46 may be welded to the pivot bracket side plate. The cables/wires for the electrical components of the trailer stand assembly 10 may be run along, and secured to, the top surface of the cable/wire holder 46 to secure the cables/wires, keep them organized and elevated off of the upper surface of the base 14.

As discussed above, the moveable support member 18 is adjustably and pivotably mounted at its bottom end via the bottom ends of the side members 28 to a respective pivot bracket 36, i.e., the left and right side members are pivotably mounted at their bottom ends to the left and right pivot brackets, respectively. To pivotably attach the moveable support member 18 to the pivot brackets 36, a pivot shaft 40 extends through corresponding and aligned pivot shaft bores 38 provided in the pivot brackets 36 and the side surfaces of the bottom ends of the side members 28. In an embodiment, the pivot shaft 40 is a 1 inch diameter circular steel bar stock. In an embodiment, the pivot shaft 40 is retained in place by left and right cotter pins 41 inserted through the pivot shaft 40 proximate the right side plate of the left pivot bracket 36 and the left side pate of the right pivot bracket 36, respectively. The releasable pivotal connection of the moveable support member 18 with the pivot brackets 36 enables the user to change the moveable support member 18 if it becomes damaged or worn.

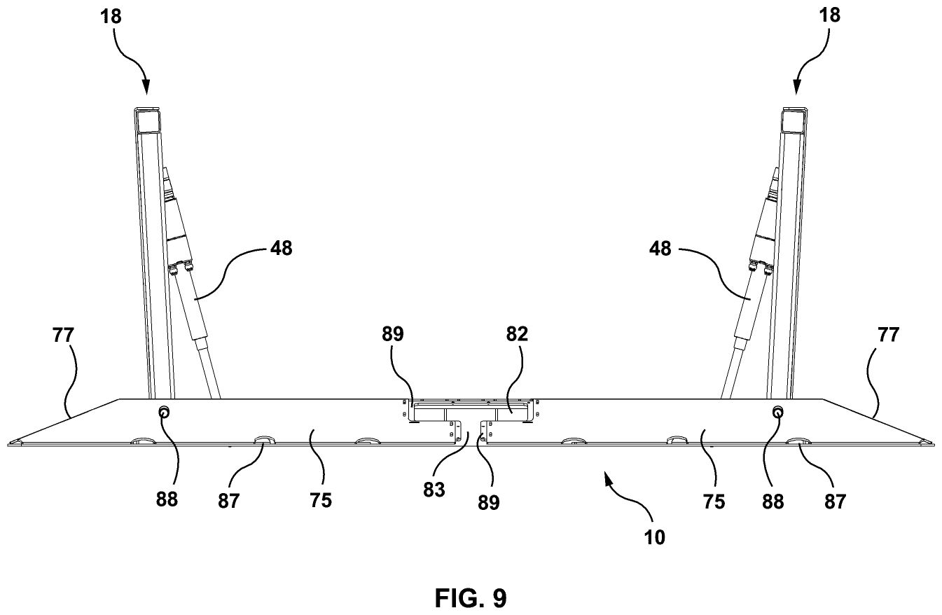

The moveable support member 18 is selectively pivotable within the pivot brackets 36 between a lowered stored position and a raised operable position. In an embodiment, in the raised operable position, the moveable support member 18 is pivoted to a position that is slightly past vertical such that the inside angle between the base 14 and the moveable support member 18 is slightly more than about 90 degrees, for example about 93 degrees, and thus the outside angle between the base 14 and the moveable support member 18 is slightly less than about 90 degrees, for example about 87 degrees (as seen in FIG. 9). Pivoting the moveable support members 18 slightly past vertical in their operable position wedges the bottom ends of the side members 28 into the base 14 and forces the inner surfaces of the bottom ends of the side members 28 to engage the wedge blocks 42 of the pivot brackets 36. This position slightly past vertical serves to lock the moveable support members 18 in the raised operable position and prevents any tendency that might exist for the moveable support members 18 to collapse inwards when supporting a trailer whose landing gear has failed or collapsed.

In an embodiment, the trailer stand assembly 10 comprises a moving mechanism 48 for moving the moveable support member 18 between a lowered stored position and a raised operable position. In an embodiment of the invention, the moving mechanism 48 is associated with the moveable support member 18. The moving mechanism 48 may be attached at one end thereof to the moveable support member 18 at a certain location and at another end thereof, to the base 14 at a certain location. The moving mechanism 48 may be any moving mechanism known to persons skilled in this art that is capable of moving the moveable support member 18 between the lowered and raised positions, including hydraulically, pneumatically, electrically, mechanically, electromechanically and the like. It will be understood that combinations of different types of moving mechanisms 48 would be possible in the trailer stand assembly 10 according to the present invention. In an embodiment, the moving mechanism 48 is a scissor-type driving device. In an embodiment, the moving mechanism 48 is a piston-type driving device.

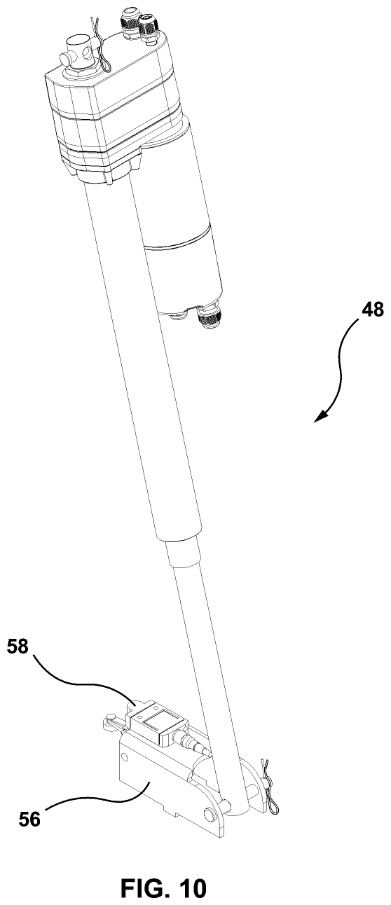

In an embodiment, the moving mechanism 48 is a linear actuator, as shown in FIG. 10. The linear actuator may be any linear actuator known to persons skilled in this art, such as, but not limited to, mechanical actuators, hydraulic actuators or cylinders, pneumatic actuators or cylinders, linear motors, telescoping linear actuators and the like. In an embodiment, the linear actuator may be an electro-mechanical actuator, such as that supplied by, for example, Joyce Dayton or DuffNorton/Grainger. The linear actuator may lift and precisely position loads of up to about 1500 pounds. It may have a cast aluminum housing, include a motor (for example, 120 VAC or 12 VDC), a potentiometer and a limit switch to control its travel length. The linear actuator may comprise a brake to ensure that the actuator holds position when power is off. The linear actuator may have a maximum speed, which will vary with load, up to about 50 inches per minute. The linear actuator may be configured, for example, for either double clevis or trunnion mounting. The linear actuator may have a travel length of about 3, 6, 12, 18, and 24 inches. In an embodiment, the linear actuator is provided by, for example, Joyce Dayton, for example Model No. JD-MA3507B8130, which can lift dynamic loads up to 3500N (787 lb), has a static load capacity of 4500N (1012 lb), has a 12 inch stroke, and has a travel speed of up to about 17 inches per min.

In an embodiment, the linear actuator is disposed between the moveable support member 18 and the base 14 and has a top end adjustably and pivotably connected to the moveable support member 18 by means of pins or the like and a bottom end adjustably and pivotably connected to the base 14 by the means of pins or the like. In an embodiment, the linear actuator comprises a housing, a motor, an upper overtube and at least one lower translating tube. The at least one lower translating tube is telescopingly and slideably received by the upper outer tube, which is slightly larger in diameter than the at least one lower translating tube to telescopingly and slidably receive the at least one lower translating tube.

In an embodiment, the trailer stand assembly 10 may comprise a top moving mechanism mount 50. In an embodiment, the top end of the linear actuator comprising the housing is adjustably and pivotably secured to the moveable support member 18 via the top moving mechanism mount 50, which may be fixedly secured to the topmost gusset 32 of the moveable support member 18 via welding or the like. The top moving mechanism mount 50 may be in the form of a bracket comprising two horizontally spaced-apart side walls having aligned apertures formed therein and creating a gap or channel therebetween in which at least a portion of the top end of the linear actuator, for example, a top portion of the housing of the linear actuator, nests. At least a portion of the top end of the linear actuator fits between the two horizontally spaced-apart side walls of the top moving mechanism mount 50 and also has an aperture formed therein, which aperture aligns with the aligned apertures of the two horizontally spaced-apart side walls of the top moving mechanism mount 50 and a clevis pin is fitted within the aligned apertures to adjustably and pivotably secure the top end of the linear actuator to the moveable support member 18.

In an embodiment, the moveable support member 18 may further comprise a locating rib 52 to identify the proper installation position of the top moving mechanism mount 50 on the top gusset 32 to ensure that when the top moving mechanism mount 50 is installed, it is co-linear with the installed bottom moving mechanism mount 56, as will be discussed in further detail below. In an embodiment, the locating rib 52 is vertically oriented and fixedly secured to the inner surface of the outer cover 24 and spans the distance between, and abuts, the lower surface of the top member 26 and the upper surface of top gusset 32, with its respective ends and is located approximately equidistant between the side members 28. In an embodiment, the locating rib 52 is a metal plate, for example, but not limited to, ¼ inch aluminum plate. Constructing the locating rib out of aluminum reduces its weight and thus the weight of the moveable support member 18 and may make it easier for the moveable support member 18 to be raised and lowered. The locating rib 52 is fixedly secured in place, via its lower edge, to the inner surface of the outer cover 24, and via its respective ends, to the lower surface of the top member 26 of the inner frame 22 and the upper surface of the top gusset 32, respectively, through welding or the like. In addition to welding, the locating rib 52 may also be keyed into the outer cover 24, as would be known to persons skilled in this art.

As discussed above, in an embodiment, the outer cover 24 of the moveable support member 18 may have at least one aperture 25 therethrough to allow access to the moving mechanism 48 associated with the moveable support member 18 when it is in the stored position. For example, if when the moveable support member 18 is in the stored position and the moving mechanism 48 fails and the moveable support member 18 is stuck in the stored position, an operator can gain access to the moving mechanism 48 from the outside through the at least one aperture 25 and disconnect the moving mechanism 48 from the moveable support member 40. For example, the operator can disconnect the top end of the linear actuator from the top moving mechanism mount 50 and thus from the moveable support member 18. Disconnecting the moving mechanism 48 from the moveable support member 18 will allow the moveable support member 18 to be manually raised from its stored position.

The bottom end of the moving mechanism 48, for example the linear actuator comprising the lower translating tube, is adjustably and pivotably secured to the base 14 via a bottom moving mechanism mount 56, which is fixedly secured to the base 14 via welding or the like. In an embodiment, the bottom moving mechanism mount 56 is in the form of a bracket comprising two horizontally spaced-apart side walls having aligned apertures formed therein and creating a gap or channel therebetween in which the lower end of the moving mechanism, for example, the translating tube of the linear actuator, nests. At least a portion of the bottom end of the linear actuator fits between the two horizontally spaced-apart side walls of the bottom moving mechanism mount 56 and also has an aperture formed therein which aperture aligns with the aligned apertures of the two horizontally spaced-apart side walls of the bottom moving mechanism mount 56 when it fits therebetween and a clevis pin is fitted within the aligned apertures to adjustably and pivotably secure the bottom end of the linear actuator to the base 56.

In an embodiment, the trailer stand assembly 10 may comprise at least one limit switch 58 to limit any further pivoting of the moveable support member 18 beyond its raised operable and/or lowered stored position and/or to signal when the moveable support member 18 is in its raised operable and/or lowered stored position.

In an embodiment, the trailer stand assembly 10 comprises a limit switch 58 to limit any further pivoting of the moveable support member 18 beyond its raised operable position. In an embodiment, the limit switch 58 is engaged by the moveable support member 18 when it reaches its raised operable position. In an embodiment, the limit switch 58 is associated with the bottom moving mechanism mount 56 and is engaged by the lower end of the moveable support member 18 when it reaches its raised operable position. In an embodiment, the bottom moving mechanism mount 56 has a top wall spanning the distance between the two horizontally spaced-apart side walls, which top wall provides a surface for mounting the limit switch 58 such that the limit switch 58 is engaged by the lower end of the moveable support member 18 when it reaches its raised operable position. In an embodiment, the limit switch 58 functions to limit any further pivoting of the moveable support member 18 beyond its raised operable position. In an embodiment, the limit switch 58 functions to limit any further pivoting of the moveable support member 18 beyond its raised operable position by communicating directly or indirectly, electrically or otherwise, with the moving mechanism 48 to stop the moving mechanism 48 from further moving the moveable support member 18. In an embodiment, the limit switch 58, when engaged by the moveable support member 18, signals that the moveable support member 18 is in its raised operable position. In an embodiment, the limit switch 58, when not engaged by the moveable support member 18, signals that the moveable support member 18 is not in its raised operable position.

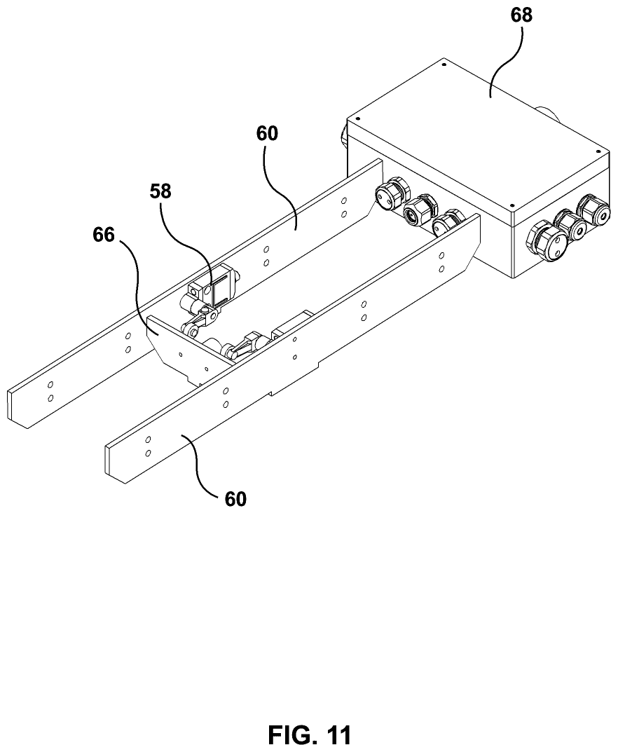

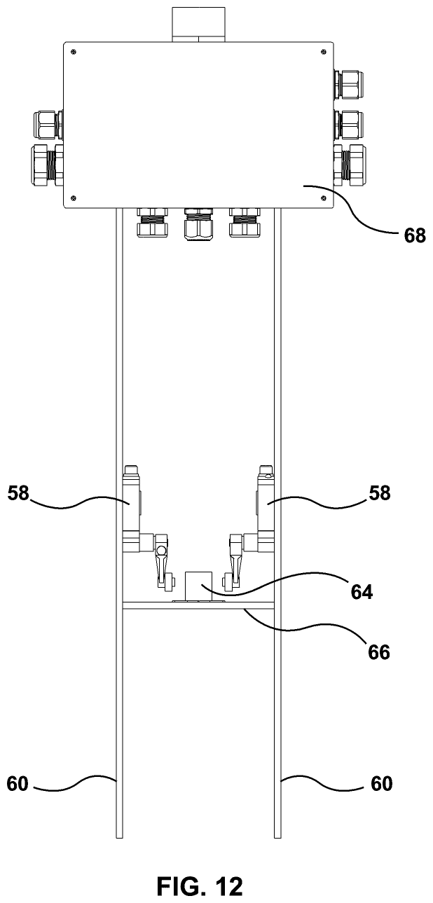

As discussed above, in an embodiment, the trailer stand assembly 10 may further comprise at least one support for the moveable support member 18 when it is in its lowered stored position. In an embodiment, the at least one support for the moveable support member 18 is a top support for the moveable support member 18 in the form of a centre bridge support 60. In an embodiment, there is a pair of centre bridge supports, a left centre bridge support and a right centre bridge support, as shown in FIGS. 11 and 12, fixedly secured to the base 14, disposed proximate the centre point thereof in a horizontally spaced apart relationship and spanning a sufficient width of the base 14 to support the moveable support member 18 when it is in its lowered stored position. The left and right centre bridge supports 60 support the left and right moveable support members 18, respectively, when they are in their lowered stored positions. In an embodiment, the left and right centre bridge supports 60 are identical. When the moveable support member 18 is in its lowered stored position, the upper end of the moveable support member 18, for example, the inner surface of the top member 26 of the moveable support member 18, rests on the centre bridge support 60 to support the weight of the moveable support member 18, especially when the moveable support member 18 is driven over by a vehicle or walked on by a pedestrian. The centre bridge support 60 also acts as a stop to prevent any further pivoting movement of the moveable support member 18 beyond its stored position. In an embodiment, the centre bridge support 60 is a flat plate member. In an embodiment, the centre bridge support 60 is a flat metal plate member, for example, but not limited to, ¼ inch steel plate. In an embodiment, the centre bridge support 60 is fixedly secured in place, via its lower edge, to the top surface of the base through welding or the like. In addition to welding, the centre bridge support 60 may also be keyed into the base 14 as would be known to persons skilled in this art.

In an embodiment, the trailer stand assembly 10 may comprise a limit switch 58 to limit the further pivoting of the moveable support member 18 beyond its lowered stored position. In an embodiment, the limit switch 58 is engaged by the moveable support member 18 when it reaches its lowered stored position. In an embodiment, the limit switch 58 is associated with the centre bridge support 60 and is engaged by the upper end of the moveable support member 18, for example, the inner surface of the top member 26 of the moveable support member 18, when it reaches its lowered stored position. In an embodiment, the limit switch 58 is mounted on the inner face of the centre bridge support 60 such that the limit switch 58 is engaged by the top member 26 of the moveable support member 18 when it reaches its lowered stored position. In an embodiment, the limit switch 58 functions to limit any further pivoting of the moveable support member 18 beyond its lowered stored position. In an embodiment, the limit switch 58 functions to limit any further pivoting of the moveable support member 18 beyond its lowered stored position by communicating directly or indirectly, electrically or otherwise, with the moving mechanism 48 to stop the moving mechanism 48 from further moving the moveable support member 18. In an embodiment, the limit switch 58, when engaged by the moveable support member 18, signals that the moveable support member 18 is in its lowered stored position. In an embodiment, the limit switch 58, when not engaged by the moveable support member 18, signals that the moveable support member 18 is not in its lowered stored position.

When the moveable support member 18 is in its lowered stored position, as shown in FIG. 1, and the moving mechanism 48, for example a linear actuator, is activated by means in a manner well known to persons skilled in this art, the moveable support member 18 is moved from this position to its raised operable position, as shown in FIG. 2. When activated, the moving mechanism 48, for example a linear actuator, pushes the moveable support member 18 upwards in a manner whereby the moveable support member 18 pivots about its lower end raising it from its lowered stored position to its raised operable position. In the raised operable position, the inner surfaces of the bottom ends of the side members 28 of the moveable support member 18 engage the respective wedge blocks 42 of the respective pivot brackets 36 and the lower ends of the side members 28 of the moveable support member 18 engage with, and wedge against, the upper surface of the base 14 which essentially locks the moveable support member 18 in its operable position. In an embodiment, the moveable support member 18 may be stopped at its operable position by the internal limit switch of the moving mechanism 48, for example a linear actuator, and/or the limit switch 58, for example which is engaged by the lower end of the moveable support member 18, that limits any further pivoting of the moveable support member 18 beyond its raised operable position.

When the moveable support member 18 is in its raised operable position, as shown in FIG. 2, and the moving mechanism 48, for example a linear actuator, is activated by means in a manner well known to those persons skilled in this art, the moveable support member 18 moves from this position to its lowered stored position shown in FIG. 1. When activated, the moving mechanism 48, for example a linear actuator, pulls the moveable support member 18 downwards in a manner whereby the moveable support member 18 pivots about its lower end lowering it from its raised operable position to its lowered stored position. In the lowered stored position, the inner surface of the top member 26 of the moveable support member 18 engages with, and rests on, the centre bridge support 60. In the lowered stored position, the inner surfaces of the side members 28 of the moveable support member 18, proximate their centre points, may also engage with, and rest on, the mid supports 44 of the pivot brackets 36, especially when the moveable support member 18 is walked on by a pedestrian or driven over by a vehicle. In an embodiment, the moveable support member 18 may be stopped in its lowered stored position by the internal limit switch of the moving mechanism 48, for example a linear actuator, and/or the limit switch 58, for example which is engaged by the top member 26 of the moveable support member 18, that limits any further pivoting of the moveable support member 18 beyond its lowered stored position.

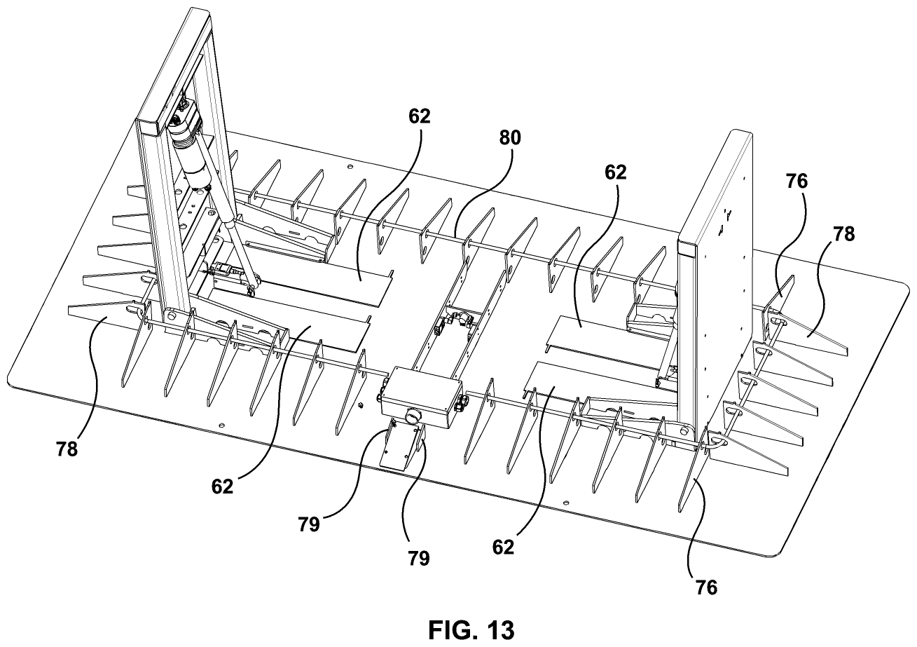

In an embodiment, the trailer stand assembly 10 may further comprise a heating mechanism 62 for heating the interior of the trailer stand assembly 10, for example, to melt snow and/or ice to prevent a build up of snow and/or ice from interfering with the proper functioning of the trailer stand assembly 10. In an embodiment, the heating mechanism 62 may be in the form of at least one heating pad attached to the upper surface of the base 14, as shown in, for example FIG. 13. In an embodiment, the heating mechanism 62 may comprise two pairs of heating pads, one pair of heating pads attached to the upper surface of the base 14 proximate the left moveable support member assembly 16 and one pair of heating pads attached to the upper surface of the base 14 proximate the right moveable support member assembly 16. However, the trailer stand assembly 10 may comprise fewer or greater number of heading pads, as would be understood by persons skilled in this art. In an embodiment, the heating mechanism 62 is located proximate the pivot brackets 36 and functions to heat the trailer stand assembly 10 in and around the pivot brackets 36 to melt snow and/or ice in this area to prevent a build up of snow and/or ice from interfering with the pivotable movement of the moveable support members 18. However, the heating mechanism 62 may be located anywhere within the trailer stand assembly 10 as long as it functions to prevent snow and/or ice from interfering with the proper functioning of the trailer stand assembly 10. The heating mechanism 62 may be attached to the trailer stand assembly 10 by any means known to persons skilled in this art. For example, when the heating mechanism 62 is in the form of one or more heating pads, the heating pads may be fixed to the upper surface of the base 14 by an adhesive, for example, an adhesive backing that is part of the heating pad itself or an adhesive that is applied separately from the heating pad.

In an embodiment, the trailer stand assembly 10 may further comprise at least one temperature sensor 64 which senses the temperature of the interior of the trailer stand assembly 10. In an embodiment, the at least one temperature sensor 64 communicates with the heating mechanism 62. In an embodiment, when the at least one temperature sensor 64 detects that the interior of the trailer stand assembly 10 has reached a certain set threshold temperature, such as, for example, but not limited to, a temperature of about or below 0 degrees Celsius, the at least one temperature sensor 64 communicates with the heating mechanism 62 which, in turn, is activated to produce heat, which in turn, heats up the interior of the trailer stand assembly 10 preventing ice and/or snow from building up in the trailer stand assembly 10 and/or melting ice and/or snow that has begun to accumulate within the interior of the trailer stand assembly 10. In an embodiment, when the at least one temperature sensor 64 detects that the interior of the trailer stand assembly 10 has reached a certain set threshold temperature, such as, for example, but not limited to, a temperature above 0 degrees Celsius, the at least one temperature sensor 64 communicates with the heating mechanism 62 which, in turn, is de-activated and stops producing heat. In an embodiment, a single temperature sensor 64 is mounted within the trailer assembly 10. In an embodiment, the single temperature sensor 64 is mounted centrally within the trailer stand assembly 10 on a temperature sensor mount 66. In an embodiment, the sensor mount 66 spans the distance between the pair of horizontally spaced apart centre bridge supports 60. In an embodiment, the temperature sensor mount 66 is a flat plate member. In an embodiment, the temperature sensor mount 66 is a flat metal plate member, for example, but not limited to, ¼ inch plate steel. In an embodiment, the temperature sensor mount 66 is fixedly secured in place at its lower edge, to the top surface of the base 14, and optionally at its left and right edges, to the left and right centre bridge supports 60, respectively, through welding or the like. In addition to welding, the temperature sensor mount 66 may also be keyed into the base 14 as would be known to persons skilled in this art. Although the temperature sensor 64 is shown mounted centrally within the trailer stand assembly 10, it may be mounted anywhere within the interior of the trailer stand assembly 10. Although a single temperature sensor 64 is shown, the trailer stand assembly 10 may comprise any number of temperature sensors 64 mounted at different locations within the trailer stand assembly 10, as would be understood by persons skilled in this art.

In an embodiment, the trailer stand assembly 10 may further comprise a terminal block 68, for example, a screw terminal block, including, for example, cord grips, for connecting and securing the electrical wires for the electrical components thereof. In an embodiment, the bottom surface of the terminal block 68 is fixedly secured to the upper surface of the base 14 at proximate the rear edge thereof approximately equidistant between the left and right sides of the base 14. The terminal block 68 may comprise a conduit fitting for the entrance and exit of the electrical wires into and out of the terminal block 68.

In an embodiment, the base 14 may comprise an aperture 70 formed therein to allow for the entrance to, and the exit of, the wires from the trailer stand assembly 10, for example, from the terminal block 68, down through the base 14 and underground to allow the end user to bury the wires to and from the trailer stand assembly 10 and run them underground between the trailer stand assembly 10 and the loading dock.

In an embodiment, the trailer stand assembly 10 may comprise a housing assembly 72 comprising a top frame 74 and a ramp assembly comprising front and rear ramps 75, a plurality of front and rear ramp gussets 76 which support the top frame 74 and the front and rear ramps 75, left and right side ramps 77 and a plurality of left and right side ramp gussets 78 which support the top frame 74 and the left and right side ramps 77. The housing assembly 72 creates a receptacle, pit, cavity or enclosure in which the interior components of the trailer stand assembly 10 are held. The terms “receptacle”, “pit”, “cavity” and “enclosure” are referred to herein interchangeably and refer to the interior area or space created by the housing assembly 72. The cavity is defined by the base 14 on the bottom, the top frame 74 on the top, the front and rear ramps 75 on the front and rear and the left and right side ramps 77 on the left and right sides. The top frame 74 is vertically spaced apart from the base 14 via the plurality of front and rear ramp gussets 76 and the plurality of left and right side ramp gussets 78.

In an embodiment, each of the front and rear ramp gussets 76 and the left and right side ramp gussets 78 has a front end terminating in a front edge, a rear end terminating in a rear edge, a top terminating in a top edge, and a bottom terminating in a bottom edge. The bottom edge is in abutting relation with the upper surface of the base 14 to affect the attachment thereto. In an embodiment, the transition from the top edge to the rear edge and from the top edge to the front edge is substantially square. In an embodiment, the top slopes downward from the rear end toward the front end such that the rear end is higher than the front end. In an embodiment, each of the front and rear ramp gussets 76 and the left and right side ramp gussets 78 is a flat plate member. In an embodiment, each of the front and rear ramp gussets 76 and the left and right side ramp gussets 78 is a flat metal plate member, for example, but not limited to, ¼ inch plate steel. In an embodiment, each of the front and rear ramp gussets 76 and the left and right side ramp gussets 78 is fixedly secured in place at its lower edge, to the upper surface of the base 14 through welding or the like. In addition to welding, each of the front and rear ramp gussets 76 and the left and right side ramp gussets 78 may also be keyed into the base 14 as would be known to persons skilled in this art.

In an embodiment, each of the front and rear ramp gussets 76 and the left and right side ramp gussets 78 has apertures formed therethrough to allow for the running of the electrical wires for the electrical components of the trailer stand assembly 10, including an illuminating mechanism 80 (discussed below). In an embodiment, the front and rear ramp gussets 76 and the left and right side ramp gussets 78 are identical to each other. In an embodiment, the front and rear ramp gussets 76 are identical to each other and the left and right side ramp gussets 78 are identical to each other. In an embodiment, each of the front and rear ramp gussets 76 has two vertically spaced apart apertures formed therethrough proximate the rear edge. In an embodiment, each of the left and right side ramp gussets 78 has a single aperture formed therethrough proximate the transition from the top edge to the rear edge. In an embodiment, there are 14 of each of the front and rear ramp gussets 76 and 5 of each of left and right side ramp gussets 78. However, a greater or fewer number of front and rear ramp gussets 76 and left and right side ramp gussets 78 may be used, as would be understood by persons skilled in this art.

In an embodiment, the trailer stand assembly 10 further comprises an illuminating mechanism 80 to illuminate the trailer stand assembly 10 in the dark or under low light conditions so that loading dock and tractor trailer operators can see the location of the trailer stand assembly 10 for proper parking and positioning of the trailer at the loading dock relative to the trailer stand assembly 10. The illuminating mechanism 80 may be illuminated at all times or may only be illuminated in low light conditions and at night when the illuminating mechanism 80 is activated either manually or for example, by a sensor (not shown) when the sensor detects low light conditions. In an embodiment, the illuminating mechanism 80 is in the form of a string or rope light that runs around the perimeter of the interior of the trailer stand assembly 10, for example, the interior of the cavity, through the aligned apertures in the ramp gussets 76 and 78. However, the illuminating mechanism 80 may take the form of any illuminating mechanism 80 that would function to illuminate the trailer stand assembly 10, as would be understood by persons skilled in this art.

In an embodiment, the top frame 74 has an opening adapted to receive the moveable support members 18. In an embodiment, the top frame 74 is rectangular and the opening has a cross-section adapted to receive the cross-section of the moveable support members 18, i.e., the opening is also rectangular. The top frame 74 receives and guides the moveable support members 18 and their movement from the lowered stored position shown in FIG. 1 to the raised operable position shown in FIG. 2. In an embodiment, the top frame 74 is a flat plate member. In an embodiment, the top frame 74 is a flat metal plate member, for example, but not limited to, ¼ inch plate steel. In an embodiment, the outer surface of the top frame 74 is checkered steel to give some texture and traction thereto for example, for workers who may walk across the trailer stand assembly 10 when it is in the lowered stored position.

In an embodiment, when the moveable support member 18 is in its lowered stored position, the moveable support member 18 is received by the top frame 74 in the opening provided thereby and the outer surface of the outer cover 24 is substantially flush with the outer surface of the top frame 74. This has advantages when the trailer stand assembly 10 is in the lowered stored position to not obstruct vehicular or foot traffic on the driveway in front of the loading dock.

In an embodiment, the entire opening of the top frame 74 or just the corners of the opening of the top frame 74 can be fitted with bushing material such as, for example, but not limited to, polyethylene, to receive the moveable support members 18. The bushing material may reduce friction and further prevent debris, snow, ice etc. from entering the interior, for example the cavity, of the trailer stand assembly 10, and may be replaced if worn, as they may be attached to the top frame 74 in an appropriate fashion.

In an embodiment, each of the front and rear ramps 75 rest on the top edges of the front and rear ramp gussets 76 and each of the left and right side ramps 77 rest on the top edges of the left and right side ramp gussets 78 and run from the top frame 74 down to the base 14 at a predetermined angle which is equal to the slope of the top edges of the ramp gussets from the rear edge to the front edge. The ramps 75 and 77 are welded at their top ends to the top frame 74 and at their bottom ends to the upper surface of the base 14. The ramps 75 and 77 may also be welded to the top edges of the ramp gussets 76 and 78, respectively. The predetermined angle is sufficient to provide a large enough cavity within the housing assembly 72 to hold the interior components of the trailer stand assembly 10 and to allow for a trailer to easily ride up and over the trailer stand assembly 10 when it is in the lowered stored position. In an embodiment, the cavity is about 5 inches to about 10 inches deep from the base 14 to the top frame 74. In an embodiment, the cavity is about 6 inches deep from the base 14 to the top frame 74. However, it will be understood that other dimensions for the cavity would be available within the range of the present invention. In an embodiment, the front and rear ramps 75 are at an angle of about 18 to about 22 degrees and the side ramps 77 are at an angle of about 20 to about 24 degrees. In an embodiment, the front and rear ramps 75 are at an angle of about 20 degrees and the left and right side ramps 77 are at an angle of about 22 degrees. However, it will be understood that other angles for the ramps 75 and 77 would be available within the range of the present invention. In an embodiment, the ramps 75 and 77 are flat plate members. In an embodiment, the ramps 75 and 77 are flat metal plate members, for example, but not limited to, ¼ inch plate steel. In an embodiment, the outer surfaces of the ramps 75 and 77 are checkered steel to give some texture and traction thereto for example, for workers who may walk across the trailer stand assembly 10 when it is in the storage position.

In an embodiment, the rear ramp 75 may comprise an aperture 82 formed therein just above the terminal block 68 to provide access to the terminal block 68 and electrical wiring of the trailer stand assembly 10 from the exterior. In an embodiment, the aperture 82 may be covered by an access cover 84 which can be removed by an operator to gain access to the terminal block 68 and the electrical wiring of the trailer stand assembly 10 from the exterior.

The access cover 84 may be fastened directly to the rear ramp 75, or to an access cover support frame 89 which may lie underneath the access cover 84, by fasteners such as screws or the like.

In an embodiment, the end user may not wish to run the electrical wires of the trailer stand assembly 10 between the trailer stand assembly 10 and the loading dock underground but may wish to run them above, and along, the ground between the trailer stand assembly 10 and the loading dock. In such an embodiment, the rear ramp 75 may comprise a conduit aperture 83 for the electrical wires exiting from, and entering into, the interior of the trailer stand assembly 10 and the trailer stand assembly 10 may further comprise an electrical conduit tray 86 aligned with the conduit aperture 83 for running the electrical wires above, and along, the ground between the trailer stand assembly 10 and the loading dock. In an embodiment, the above-ground electrical conduit tray 86 may comprise one or more ground plates for mounting to the surface 12 between the trailer stand assembly 10 and the loading dock, one or more top plates vertically spaced apart from the one or more ground plates, one or more angled left side plates and one or more angled right side plates running between, and connecting, via fasteners or welding, the one or more top plates with the one or more ground plates. The one or more angled side plates are angled to create a ramp to allow for vehicles to easily drive over the electrical conduit tray 86. The electrical conduit tray 86 is a housing that provides a cavity in which the electrical wiring can be run. In an embodiment where the electrical conduit tray 86 comprises more than one ground plate, more than one top plate, and more than one angled side plate, these plates can be fastened end to end to one another via fasteners, welding or the like.

In an embodiment where the end user wishes to run the electrical wires between the trailer stand assembly 10 and the loading dock underground, conduit aperture 83 in the rear ramp may be covered by a plate cover 85.

In an embodiment, the rear ramp 75 may be formed in two pieces shaped such they provide the aperture 82 for access to the terminal block 68 and/or the conduit aperture 83. In this embodiment, the trailer stand assembly 10 may comprise two gussets 79 for the conduit area, one on each side of the aperture 82 and/or conduit aperture 83 to support the access cover 84 and/or the plate cover 85.

In an embodiment, the front and rear ramps 75 may comprise apertures 88 proximate the location of the pivot shafts 40 of the moveable support member assemblies 16 to allow for removal of the pivot shafts 40 from the moveable support member assemblies 16 by sliding the pivot shafts 40 through one of the apertures 88 once the cotter pins 41 holding the pivot shafts 40 have been removed.

In an embodiment, the front, rear, left side and right side ramps may comprise cut-outs 87 along the bottom edges thereof where they meet with the base 14. These cut-outs 87 allow for snow and ice to melt out from, water to drain out from, and debris to be washed out from, the interior or cavity of the trailer stand assembly 10.

In an embodiment, the trailer stand assembly 10 may comprise a control device 90 for controlling the various functions of the trailer stand assembly 10. The control device 90 may be mounted at the loading dock, such as on the exterior or interior wall of the loading dock. The control device 90 may control all of the various functions of the trailer stand assembly 10, including the raising and lowering of the moveable support members 18, the limit switches 58, the heating mechanism 62, the temperature sensor 64, the illuminating mechanism 80 and the light sensor (if present), and may coordinate signals received from, for example, the limit switches 58, the temperature sensor 64 and the light sensor (if present). In an embodiment, control device 90 may comprise indictor signals such as lights and/or sounds which indicate when the moveable support members 18 are in their operable position and when they are in their stored position. The control device 90 may also be integrated with other systems of the loading dock, such as dock levelers, wheel chocks and the like.

Accordingly, a trailer may be driven over the trailer stand assembly 10 when it is in the lowered stored position as shown in FIG. 1. Thereafter, the trailer is parked at the loading dock with the trailer stand assembly 10 aligned underneath the nose portion of the trailer such that when the moving mechanism 48 is activated, the moveable support members 18 are raised from the lowered stored position shown in FIG. 1 to their operable position shown in FIG. 2 so as to be capable of supporting a trailer if and when its landing gear fails or collapses and thus preventing such a trailer from tipping over or nose diving. Thereafter, once the loading or unloading of the trailer is completed and the trailer is once again supported by the prime mover or a shunt truck, the trailer stand assembly 10 may be lowered in the fashion described and the trailer may be driven thereover when it is pulled away from the loading dock by the prime mover or shunt truck.

The trailer stand assembly 10 of the present invention described herein is a stand-alone unit that can be incorporated with existing loading docks. This would only require mounting of the trailer stand assembly 10 of the present invention to the surface 12 of the driveway in front of the existing loading dock.

The trailer stand assembly 10 of the present invention described hereinabove provides a safe trailer stand assembly 10 which can be easily and quickly returned to the stored position thereby providing a safe surface to be driven over or walked on and not obstructing vehicular or pedestrian traffic on the driveway in front of the loading dock.

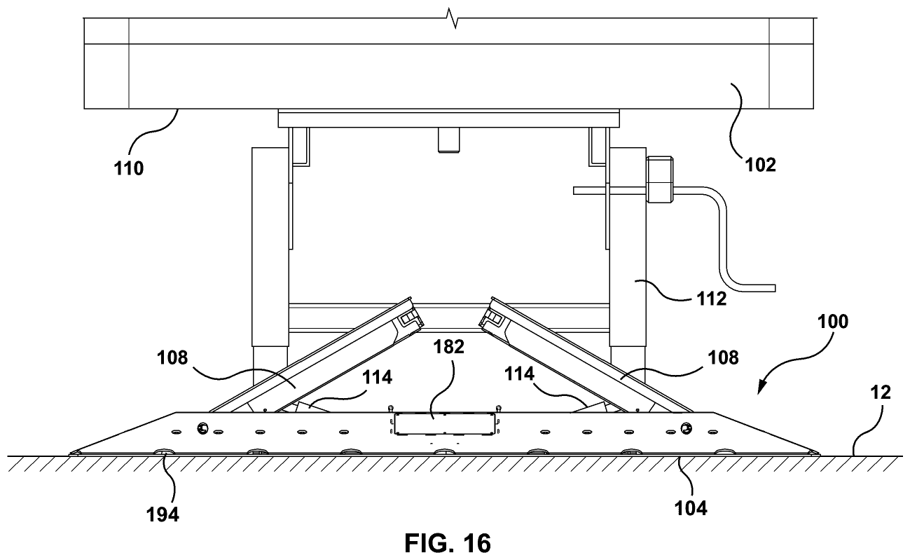

With reference to FIGS. 16 to 25, in accordance with another embodiment there is provided a trailer stand assembly 100. Trailer stand assembly 100 may share aspects of trailer stand assembly 10 discussed hereinabove to the extent that such aspects do not conflict with the aspects of trailer stand assembly 100 described hereinbelow. The use of different reference numerals or names for like aspects of the described embodiments is not necessarily meant to convey that such aspects are different from one another, and the use of like reference numerals or names for differently described aspects of the described embodiments is not necessarily meant to convey that such aspects are the same or similar to one another.

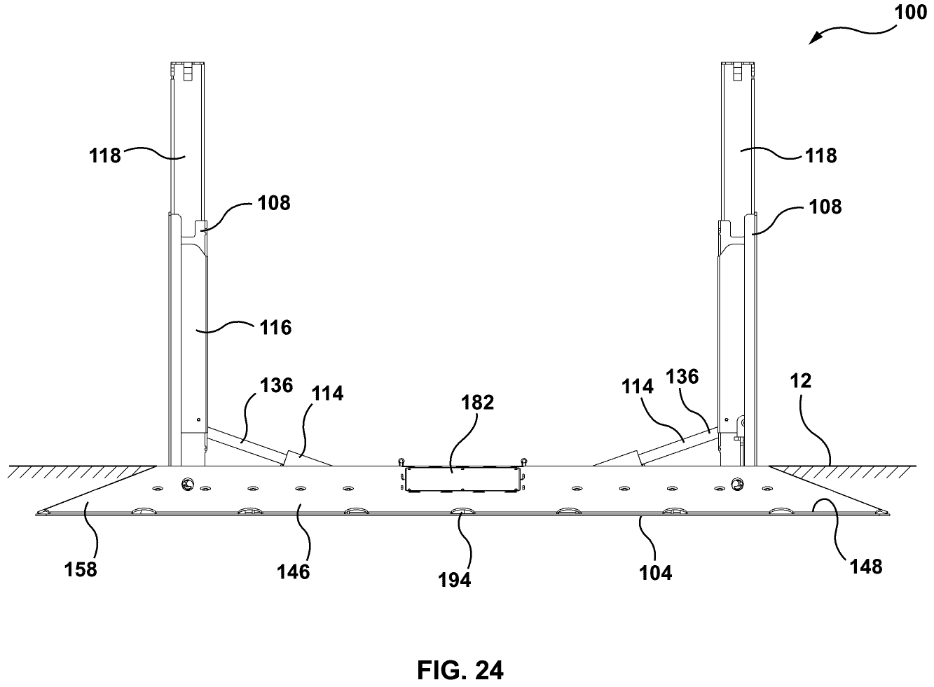

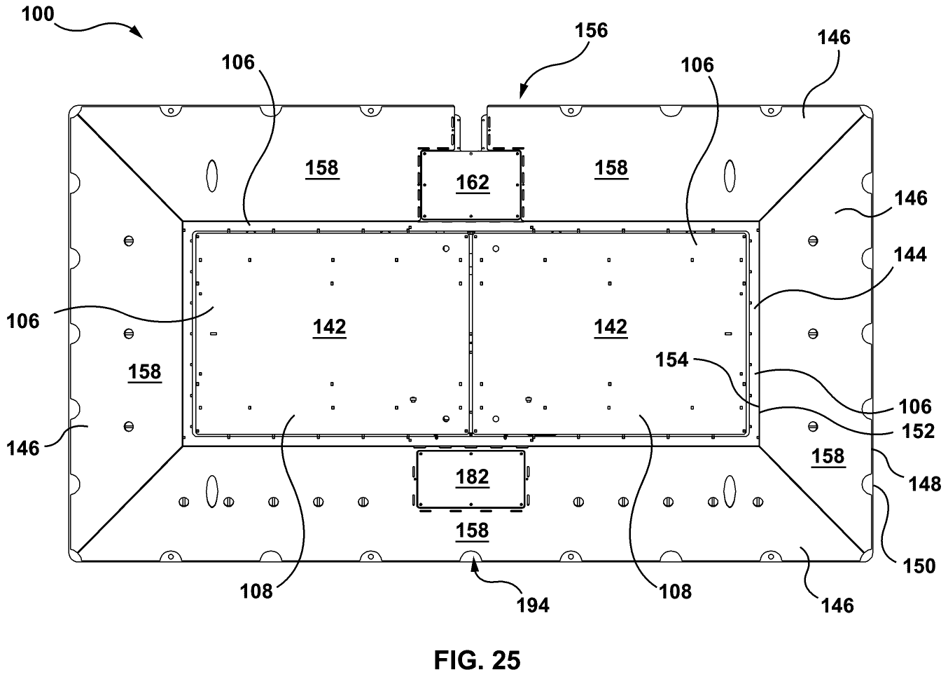

With reference to FIGS. 16 to 25, trailer stand assembly 100 may comprise a retractable trailer stand assembly 100 for supporting a trailer 102. Trailer stand assembly 100 may comprise a support base 104 for mounting atop a surface 12, as shown in FIGS. 16, 19 and 26, or at least partially under a surface 12, as shown in FIG. 24. For example, as shown in FIG. 24, trailer stand assembly 100 may be mounted beneath a surface 12 such that an upper surface 106 (shown most clearly in FIG. 25) is substantially flush or level with the surface 12.

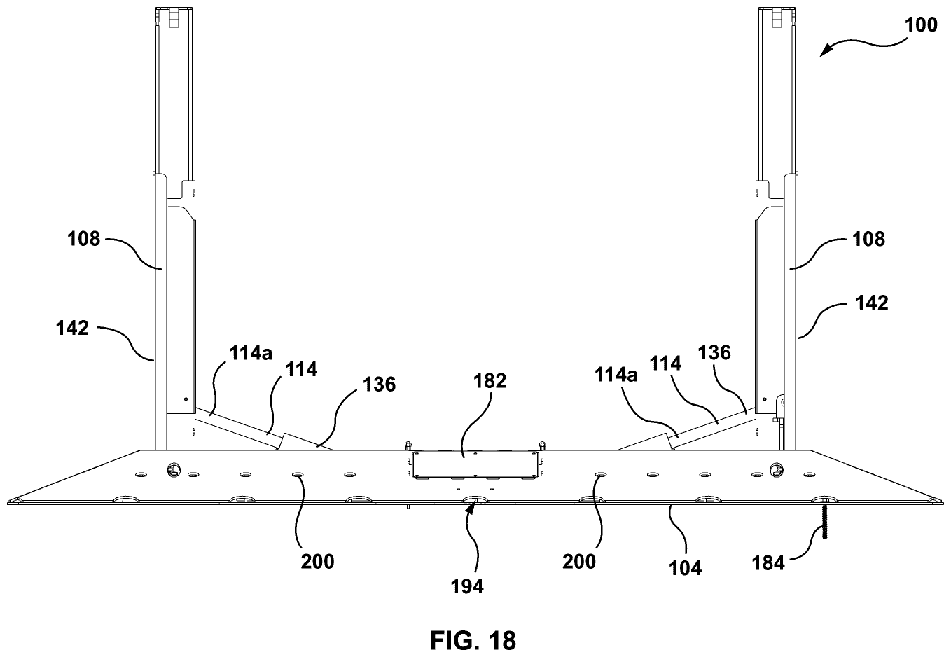

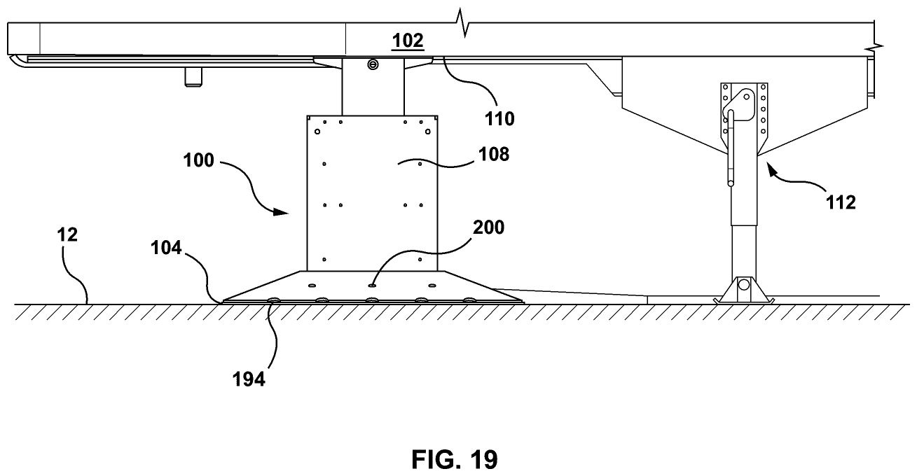

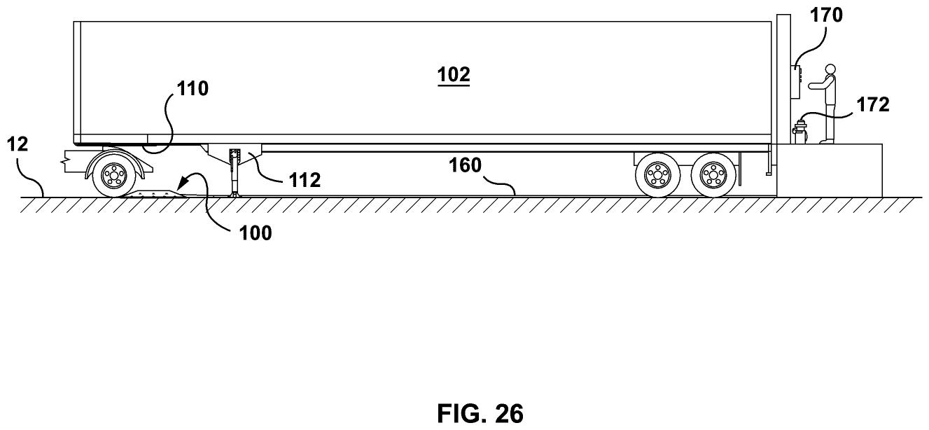

Trailer stand assembly 100 may further comprise one or more extendable support members 108 attached to the support base 104 and moveable between a first, storage position (shown in FIGS. 25 and 26) and a second, supporting position (shown in FIGS. 18-24). When in the second position, each of the extendable support members 108 supports a trailer 102 by contact with an underside 110 of the trailer 102, as shown in FIG. 19.

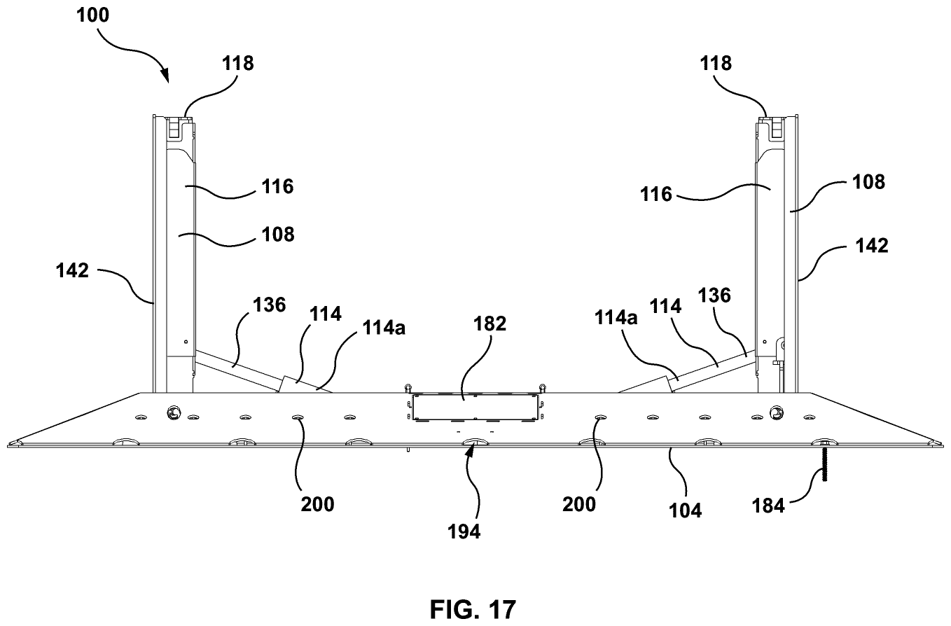

Trailer stand assembly 100 may further comprise a moving mechanism 114 associated with each of the one or more support members 108, for moving the support member(s) 108 between the first, storage position and the second, supporting position. In accordance with some embodiments, each moving mechanism 114 may comprise a first moving mechanism 114a, such as for moving each support member 108 to a position between the first, storage position and the second, supporting position (such as the intermediate positions shown in FIGS. 16 and 17) and a second moving mechanism 114b for moving each support member 108 to the second, supporting position from an intermediate position. It will be appreciated that other moving mechanisms capable of transitioning or moving the support members 108 between the first and second positions, including any intermediate position, such as moving mechanisms that each comprise a single moving mechanism rather than first and second moving mechanisms, may be used.

In accordance with some embodiments, each of the extendable support member(s) 108 may comprise a base structure 116 and at least one raisable structure 118, at least one of which may be slidably attached to the base structure 116. In the embodiment shown in FIGS. 16-24, each extendable support member comprises a base structure 116 and one slidably attached raisable structure 118. Each slidably attached raisable structure 118 may be slidably attached to a respective base structure 116 or, in embodiments using more than one raisable structure 118 for each extendable support member 108, another of the at least one slidably attached raisable structure 118, such as in adjacent relation to one another, as shown in the nested or telescopic configuration of the base structures 116 and the respective raisable structures 118 shown in FIGS. 16-24.

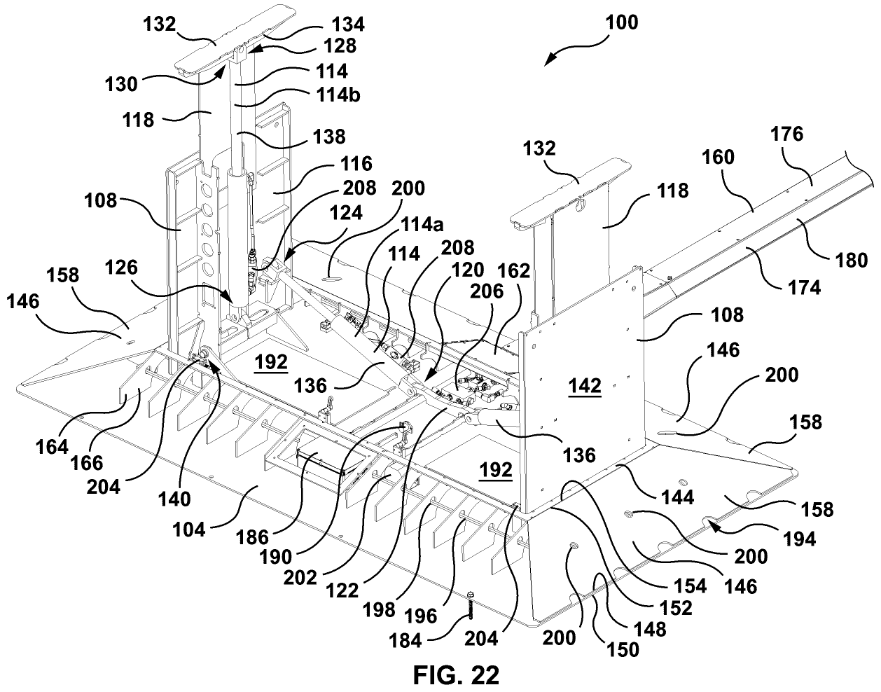

With reference to FIG. 22, each first moving mechanism 114a may be attached at one end 120 thereof to the support base 104 and at another end 124 thereof to a respective base structure 116. Each second moving mechanism 114b may be attached at one end 126 thereof to the respective base structure 116 and at another end 128 thereof to a contacting end 130 (i.e., the end of each raisable structure 118 which in the second, supporting position, contacts the trailer underside 110) of a respective raisable structure 118. Such connections may be by any known connection mechanism, such as the connecting structure 122 (see FIG. 22), to which the first moving mechanism 114a is pivotally attached in an embodiment.

With reference to FIGS. 25 and 26, in some embodiments, each base structure 116 and slidably attached raisable structure 118 is in a storage position when the respective extendable support members 108 are in the first position. FIG. 17 shows each base structure 116 and slidably attached raisable structure 118 in an upright position at an intermediate position of the respective extendable support member 108 between the first and second positions; i.e., when the respective extendable support member 108 is moved out of the first position by the first moving mechanism 114a (FIG. 16 depicts the base structures 116 and slidably attached raisable structures 118 partway through their transition from their storage positions (shown in FIGS. 25 and 26) to their upright positions (shown in FIG. 17)).

In the embodiment shown in FIGS. 16-25, when the trailer stand assembly 100 is in the upright position shown in FIG. 17, it is capable of supporting a trailer in a manner similar to the embodiment of trailer stand assembly 10 previously described (i.e., without sustained contact with an underside 110 of a trailer 102, but ready to stop a trailer tipping forward onto the trailer stand assembly, so that the trailer may fall a short distance (e.g., 1 to 2 inches) before it is stopped by the trailer stand assembly). As such, each first moving mechanism 114a moves each base structure 116 and slidably attached raisable structure 118 from the storage position to the upright position, and in order for the trailer stand assembly 100 to provide support to a trailer 102 through contact (as shown in FIG. 19), each second moving mechanism 114b then slidably raises each raisable structure 118 until each raisable structure 118 contacts the underside 110 of the trailer 102, such that each extendable support member 108 is in the second position (shown in FIGS. 18-24).

In accordance with some embodiments, each raisable structure 118 is in a position that is substantially adjacent a respective base structure 116 when the respective extendable support member 108 is in the first position shown in FIG. 25 (such substantially adjacent configuration also shown in FIG. 17, showing each raisable structure 118 substantially nested within a respective base structure 116). Further, each raisable structure 118 may be at least partially raised out of the substantially adjacent position (such as the substantially nested position shown in FIG. 17) when the respective extendable support member 108 is in the second position, as shown in FIGS. 18-24. In this way, trailer stand assembly 100 is expected to be able to raise the raisable structure(s) 118 to varying degrees, to contactingly support the undersides 110 of trailers 102 of various heights over a surface 12.

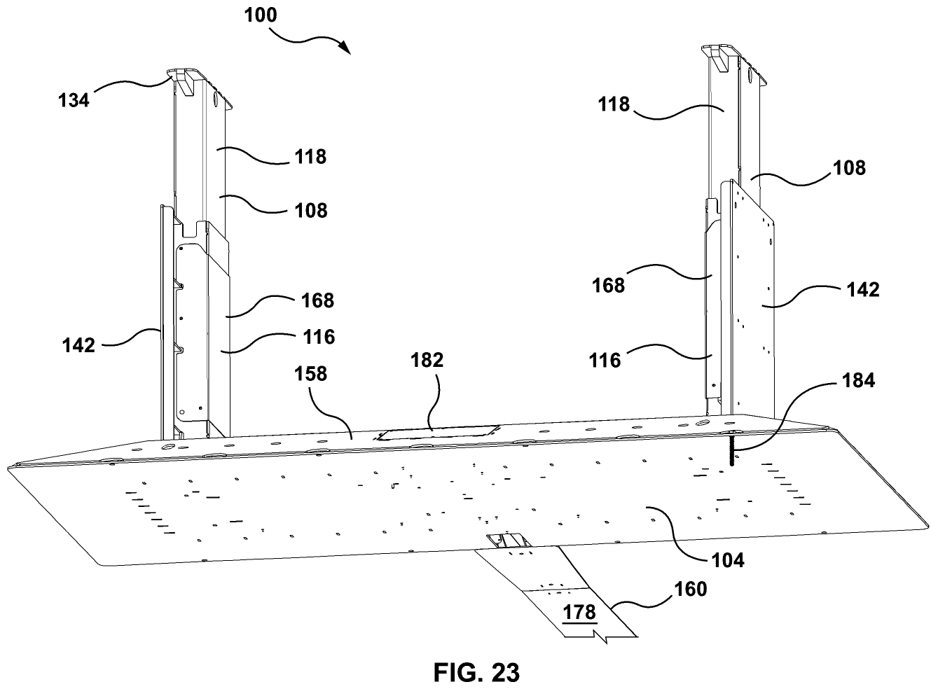

Each contacting end 130 of each raisable structure 118 may comprise a contacting surface 132 for contacting the underside 110 of a trailer 102 when each extendable support member 108 is in the second position. As shown in FIGS. 22 and 23, each second moving mechanism 114b may attach at its end 128 to a side 134 of the contacting end 130 that is opposite the contacting surface 132. Contacting surface 132 may comprise any suitable material for supporting a trailer through contact, such as metal. Further, contacting surface 132 may be checkered or otherwise comprise some textured pattern to increase friction between the contacting surface 132 and an underside 110 of a trailer 102 supported thereby.

In accordance with some embodiments, each first moving mechanism 114a may comprise a first hydraulic cylinder 136 and each second moving mechanism 114b may comprise a second hydraulic cylinder 138. Each first hydraulic cylinder 136 may be pivotally attached at end 120 thereof to the support base 104, and pivotally attached at end 124 thereof to a respective base structure 116, as shown in FIG. 22. Also as shown in FIG. 22, each second hydraulic cylinder 138 may be attached at end 126 thereof to a respective base structure 116, and may also be attached at end 128 thereof to a side 134 of a contacting end 130 of a respective raisable structure 118. Further, each base structure 116 may be pivotally attached to support base 104 such as by a pivot assembly 140, as shown in FIG. 22. In this way, pivoting of a base structure 116 about a pivot assembly 140 causes the attached second hydraulic cylinder 138 to similarly pivot to the upright position, where it is ready to be actuated to raise a respective raisable structure 118 until contact is made between the contacting surface 132 and the underside 110 of a trailer 102. Pivot assembly 140 is depicted in FIG. 22 as a gusset structure fixedly attached to the support base 104 and with a pivot rod passing therethrough and through a lower section of the base structure 116 through another pivot assembly on the other end of the base structure 116; it will be appreciated that the specific components making up any such connecting means described herein, such as the pivoting means described herein, may comprise any combination of known structures or mechanisms for effecting the described movements and generally, for effecting the ability to raise extendable support members 108 from a first position, to an intermediate position that clears an overhead trailer, after which the extendable support members 108 can be upwardly extended, or raised, until supportive contact is made with a trailer's 102 underside 110. While such action has been described herein by way of the base structures 116 and slidably attached raisable structures 118, as well as the first and second hydraulic cylinders 136, 138, it will be appreciated that other mechanisms permitting such movement from the first position to an intermediate position and then to a second, supporting position may be employed. Further, in some embodiments, a mechanism permitting a single upward movement of one or more contacting surfaces may be employed (e.g., where a scissor-type driving mechanism is used to move the contacting surface(s) upward, directly from the first to the second position).

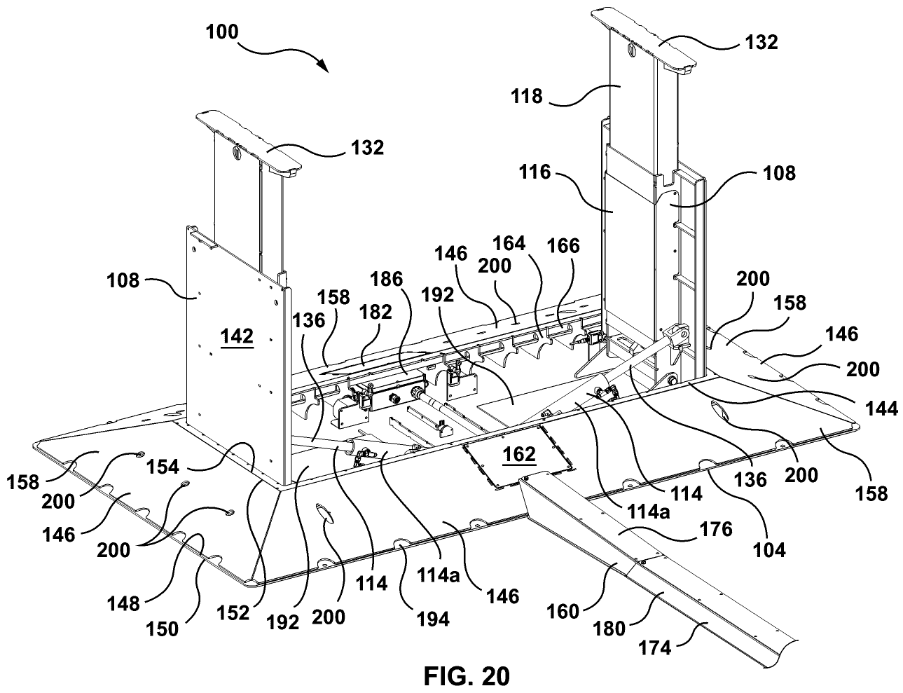

With reference to FIG. 25, trailer stand assembly 100 may further comprise an upper surface 106. When the trailer stand assembly 100 is in the first position, the upper surface 106 may provide a surface 106 over which pedestrians and/or vehicles, including loaded trailers, may traverse. Each base structure 116 may have attached thereto an outer cover 142 such that when each base structure is in the storage position, the upper surface 106 comprises at least each of the outer covers 142. As shown in FIGS. 20-22 and 25, upper surface 106 may further comprise additional structures which may surround the outer covers 142, and/or lie between the contacting surfaces 132 (not shown), such as top frame 144.

Trailer stand assembly 100 may also comprise at least front, rear, right, and left side walls 146 removably attached between the support base 104 and the upper surface 106. Bottom ends 148 of the side walls 146 may abut outer edges 150 of the support base 104, and top ends 152 of the side walls 146 may abut outer edges 154 of the upper surface 106. Each side wall may comprise a single, unitary piece, or multiple pieces. For example, in the example embodiment shown in FIG. 20, the rear side wall 146 comprises two pieces separated by a conduit 160 and a rear access panel 162, whereas each of the remaining side walls 146 comprises a single piece. It will be appreciated that other configurations for the side walls is possible. For example, the rear side wall 146 shown in FIG. 20 may instead comprise a single, unitary piece connected over the conduit 160, so that there is no separate rear access panel 162, in which case access to the interior components that would otherwise lie under rear access panel 162 would be achieved by removal of the entire rear side wall 146.

At least the support base 104, the front, rear, right, and left side walls 146, and the upper surface 106 may form an enclosure 156 for receiving each of the extendable support member(s) 108 and each of the first and second moving mechanisms 114a, 114b when each of the extendable support member(s) 108 is in the first position. The enclosure 156 may protect to some degree the inner contents of the trailer stand assembly 100 from external elements, such as dirt, debris, rodents, and the like, especially when the trailer stand assembly 100 is in the first position, but also to some degree with the trailer stand assembly 100 is in the second position or some position between the first and second positions.

In accordance with some embodiments, and as shown in the figures, each of the support base 104 and the upper surface 106 may comprise a substantially quadrilateral shape, and the support base 104 may have a longer length and a longer width than the length and width of the upper surface 106 such that each of the front, rear, right, and left side walls 146 forms a ramp 158. Where the trailer stand assembly 100 is mounted atop a surface 12, the ramps 158 are expected to support, and further facilitate, the traversing over trailer stand assembly 100 by pedestrians and vehicles, including loaded trailers. Ramps 158 are also expected to improve safety, as they may reduce the possibility of pedestrians tripping and/or falling as they walk over the trailer stand assembly 100. Ramps 158 may also facilitate traversal of vehicles over the trailer stand assembly 100. It will be appreciated that all sides of the trailer stand assembly 100 need not be sloped so as to form a ramp; it may be that only one side wall 146, or some subset of the total number of side walls 146, or all side walls 146 of the trailer stand assembly 100 comprise a ramp 158.

In some embodiments, trailer stand assembly 100 may comprise no ramps. For example, the support base 104 and the upper surface 106 may have substantially the same shape, with substantially the same dimensions, so that each side wall 146 attached between the support base 104 and the upper surface 106 has a substantially vertical, non-ramped or non-sloped configuration. The shape of the support base 104 and the upper surface 106 may be any suitable shape. For example, the support base 104 and the upper surface 106 may comprise substantially a quadrilateral, such as a substantially square or rectangular shape.

Trailer stand assembly 100 may further comprise a plurality of support structures 164. In embodiments of the trailer stand assembly 100 comprising one or more ramps 158, the support structures 164 may be positioned between the support base 104, and the ramps 158 and the upper surface 106 when the assembly 100 is in the first position, and may be fixedly attached therebetween to provide rigid support to the ramps 158 and the upper surface 106.

In embodiments comprising no ramps, the support structures 164 may be positioned between the support base 104 and the upper surface 106, when the trailer stand assembly 100 is in the first position, and may be fixedly attached therebetween to provide rigid support to the upper surface 106. The support structures 164 may also support at least a part of the upper surface 106 when the assembly 100 is in the second position, such as by contact with the top frame 144 of the upper surface 106. The support structures 164 are expected to prevent collapse of the enclosure 156 when the trailer stand assembly 100 is in the first position, during traversal of routine loads over the trailer stand assembly 100, such as pedestrians and vehicles, including loaded trailers. The support structures 164 may also serve to prevent collapse of the ramps 158 and/or a portion of the upper surface 106 when the trailer stand assembly 100 is in the second position when routine loads are applied thereto. Generally, the support structures 164 are expected to increase the structural stability of the trailer stand assembly 100 in either the first or second positions.

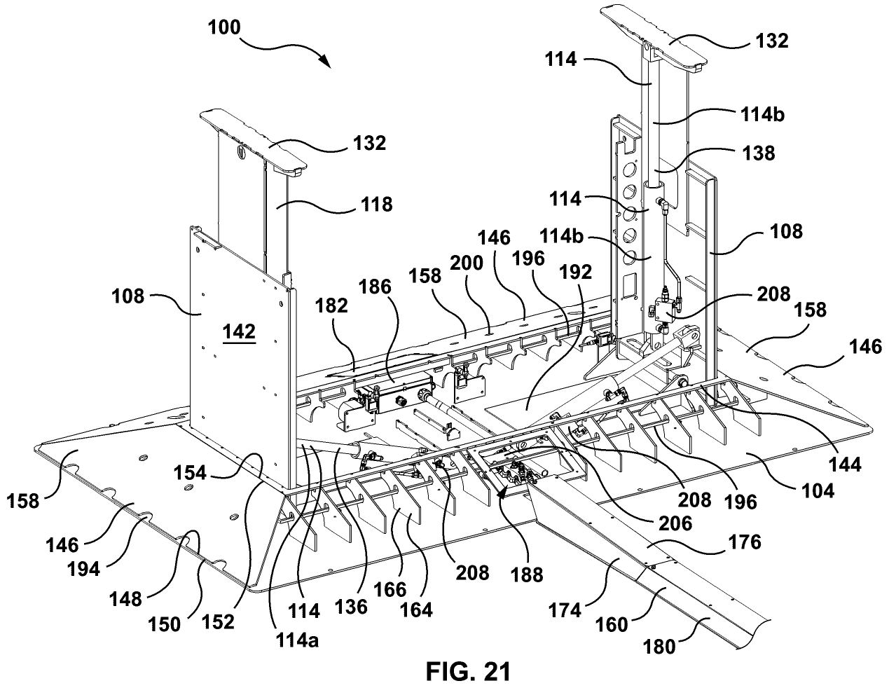

Support structures 164 may comprise gussets 166 supporting the ramps 158 and possibly a top frame 144, as shown in FIGS. 21 and 22. Support structures 164 may also comprise base structure frames 168 (see FIG. 23) which, when the trailer stand assembly 100 is in the first position, are positioned between the support base 104 and the upper surface 106 to provide the aforementioned rigid support to the upper surface 106. It will be appreciated that the support structures 164 may comprise other forms or arrangements of support structures than those described herein, provided that rigid support to the upper surface 106, or the upper surface 106 and the ramps 158, and/or to the trailer stand assembly 100 generally, is provided.

Each extendable support member 108 may be pivotally attached to the support base 104 generally under opposite sides of the upper surface 106, as shown in FIGS. 16-24, such that when the extendable support members 108 are in the first position, the contacting surfaces 132 of the contacting ends 130 of the raisable structures 118 are in close adjacent relation to one another, such as in contacting relation, as shown in FIG. 25. In such embodiments, during operation of the trailer stand assembly 100, actuation of each first hydraulic cylinder 136 causes each base structure 116 to pivot about the pivotal attachment of the respective extendable support member 108 to the support base 104 so that the extendable support members 108 pivot away from one another until each base structure 116 and slidably attached raisable structure 118 (or each extendable support member 108) is in the upright position. Thereafter, actuation of each second hydraulic cylinder 138, once each base structure 116 and slidably attached raisable structure 118 is in the upright position, causes each raisable structure 118 to slidably raise until each contacting surface 132 of the contacting end 130 of the raisable structure 118 contacts the underside 110 of a trailer 102 such that each extendable support member 108 is in the second position.

In accordance with some embodiments, the moving mechanism 114 may be powered and controllable by a remote power source and control device 170 electrically connected to the trailer stand assembly 100 by wired connection(s). In other embodiments, some or all control signals may be transmitted wirelessly rather than by wired connection(s), in which case the trailer stand assembly 100 may be equipped with suitable communications components, such as receivers, transmitters, transceivers, antennae, and the like. Furthermore, in some embodiments, the first hydraulic cylinder 136 and the second hydraulic cylinder 138 may receive hydraulic fluid under pressure from, and return hydraulic fluid to, a remotely located hydraulic assembly 172 comprising a hydraulic motor and other suitable components for hydraulic assemblies as would be known in the art. In some embodiments, the power source and/or control device 170, and/or the hydraulic assembly 172, may not be located remotely from the trailer stand assembly 100, but rather adjacent or near the trailer stand assembly 100. In other embodiments, some of the power source, the control device 170, and the hydraulic assembly 172 may be local to the trailer stand assembly 100 while others of those components may be located remotely from the trailer stand assembly 100.

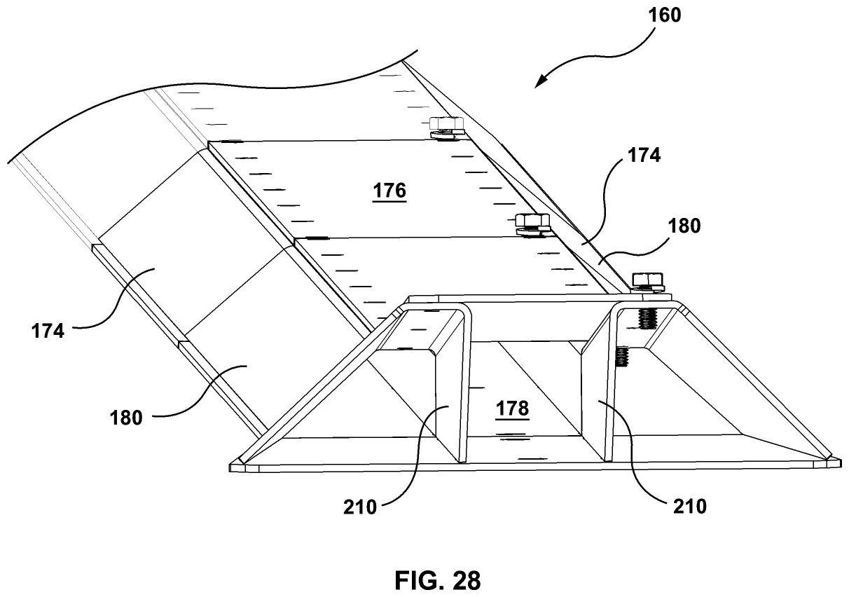

A wired connection (which may comprise one or multiple wires), and/or hydraulic fluid lines, may be enclosed within a conduit 160 mounted atop or at least partially under the surface 12, to connect the trailer stand assembly 100 to a power source, control device 170 and/or hydraulic assembly 172 located remotely from the trailer stand assembly 100, as shown in FIG. 26. As more clearly shown in FIG. 28, an upper conduit surface 176 may comprise a smaller width than a lower conduit surface 178 so that conduit side walls 174 form conduit ramps 180 which, as described above with respect to the ramp(s) 158 of the trailer stand assembly 100, may improve safety, as they may reduce the possibility of pedestrians tripping and/or falling as they walk over the conduit 160. Conduit ramps 180 may also facilitate traversal of vehicles over the conduit 160, and conduit 160 may comprise internal conduit support structures 210 to provide rigid support between the upper and lower conduit surfaces 176, 178. It will be appreciated that all sides of the conduit 160 need not be sloped so as to form a ramp; it may be that only one conduit side wall 174 comprises a conduit ramp 180. Further, the upper conduit surface 176 and the lower conduit surface 178 may have substantially the same shape with substantially the same dimensions, so that each conduit side wall 174 attached between the upper conduit surface 176 and the lower conduit surface 178 has a substantially vertical, non-ramped or non-sloped configuration. The shape of the upper conduit surface 176 and the lower conduit surface 178 may be any suitable shape. Alternatively, the conduit 160 may comprise a shape that does not have an upper conduit surface and/or a lower conduit surface, such as a triangular prism shape or a cylindrical shape.

Trailer stand assembly 100 and/or the conduit 160 may be installed under a surface 12 such that their upper surfaces 106, 176 are substantially flush with the surface 12, as shown for the trailer stand assembly 100 in FIG. 24, in which case ramped side walls 146, 174 for the trailer stand assembly 100 and the conduit 160 would not be necessary (although where the trailer stand assemblies 100 and/or conduits 160 are made with a ramped configuration, they may still be installed under a surface 12). With such an installation, the upper surfaces 106, 176 of the trailer stand assembly 100 and the conduit 160 being substantially flush with the surface 12 may further improve safety by further reducing the possibility of pedestrians tripping and/or falling as they walk over the trailer stand assembly 100 and the conduit 160, and further facilitating vehicle passage over the trailer stand assembly 100 and the conduit 160.

In some embodiments, the various walls or panels of the trailer stand assembly 100 and the conduit 160 may be removable, such as some or all of the front, rear, right, and left side walls 146, any component of the upper surface 106 (including the outer cover(s) 142), the support base 104, the rear access panel 162, the front access panel 182, the conduit side walls 174, the upper conduit surface 176, and/or the lower conduit surface 178. Where the trailer stand assembly 100 and the conduit 160 are installed with their upper surfaces 106, 176 substantially flush or level with the surface 12, removable upper surfaces 106, 176 would permit access to the interiors of the trailer stand assembly 100 and conduit 160. Such removable panels and walls are expected to facilitate the troubleshooting of problems that may arise or general maintenance, as required. While the upper conduit surface 176 shown in FIGS. 19-22 is lower than the upper surface 106 of the trailer stand assembly 100, conduit 160 may be attached or configured in a manner such that the upper conduit surface 176 is substantially flush or level with the upper surface 106. Further, in the embodiment shown in FIGS. 19-22, in-ground installation of the trailer stand assembly 100 may be such that the upper surface 106 is substantially flush or level with the surface 12 while the conduit 160 is buried under the surface 12.

In-ground or above-surface installations of the trailer stand assembly 100 and/or the conduit 160 may be within a concrete enclosure or onto a concrete pad, respectively, so as to provide a stable substrate to which to attach the trailer stand assembly 100 or the conduit 160, such as by a bolted connection 184 (one example of which is shown in FIGS. 17, 18, 22, and 23).

Trailer stand assembly 100 may further comprise an electrical junction box 186 housing electrical connections between the power source and control device 170 and the electrical components of the trailer stand assembly 100. Trailer stand assembly 100 may further comprise at least one removably attached access panel, such as front access panel 182 for access to the electrical junction box 186. In some embodiments, and as shown in FIGS. 20-22 and 25, trailer stand assembly 100 may comprise two removably attached access panels, the front electrical junction box access panel 182, and a second access panel comprising a rear access panel 162 for access to a hydraulic junction assembly 188. The hydraulic junction assembly 188 may comprise connections between the hydraulic feed and return lines from and to the hydraulic assembly 172, and the first and second hydraulic cylinders 136, 138, as well as any other components required for the functioning of the hydraulic system of trailer stand assembly 100 as would be known in the art.

In accordance with some embodiments, at least the support base 104, the upper surface 106, and the at least front, rear, right, and left side walls 146 of the trailer stand assembly 100 are comprised of a thermally conductive metal, such as such as ¼ inch aluminum, although other types of thermally conductive metal and suitable dimensions thereof are possible. One-quarter inch aluminum is expected to provide a suitable combination of thermal conductivity and structural rigidity while providing a lightweight and cost-effective material for the trailer stand assembly 100 (lighter weight outer covers 142 being expected to facilitate the transitioning of the extendable support members 108 between the first and second positions). Other components of the trailer stand assembly 100 may also comprise ¼ inch aluminum (or a suitable alternative, as described above), such as contacting end 130 or conduit 160. In some embodiments, conduit 160 may comprise PVC piping.

Trailer stand assembly 100 may further comprise a temperature sensor and switch 190 (see FIG. 22) and at least one heating pad 192 attached to the support base 104 and positioned between the support base 104 and the extendable support member(s) 108 when the trailer stand assembly 100 is in the first position. The temperature sensor and switch 190 may be communicatively coupled to the heating pad(s) 192, such as by wired electrical connection, and cause the heating pad(s) 192 to activate and radiate heat when the temperature sensor and switch 190 detects that an ambient temperature is at or below a threshold temperature. The threshold temperature may be configurable, and may comprise, for example, 0° Celsius, 0° Fahrenheit, or any other suitable temperature for triggering activation of the heating pad(s) 192.

With at least the support base 104, the upper surface 106, and the at least front, rear, right, and left side walls 146 of the trailer stand assembly 100 being comprised of a thermally conductive metal, it is expected that heat radiated from the heating pad(s) 192 may heat the thermally conductive metal components of the trailer stand assembly 100, either through direct contact (such as with the support base 104) or through thermal conduction via intermediate, contacting components, while also heating the air space above the heating pad(s) 192. In this way, snow or sleet that may have settled on the interior of the trailer stand assembly 100 (such as when the trailer stand assembly 100 is in the second position under snowy conditions), may be melted through activation of the heating pad(s) 192 by the temperature sensor and switch 190 when the threshold temperature is reached, which is expected to prevent ice and snow accumulation. In accordance with some embodiments, the at least front, rear, right, and/or left side walls 146 may have formed therein at least one cut-out 194, each cut-out 194 for drainage of meltwater from an interior of the trailer stand assembly 100 to an exterior of the trailer stand assembly 100, such as meltwater produced by the melting of ice or snow by the activation of the heating pad(s) 192.

In accordance with some embodiments, the trailer stand assembly 100 may further comprise an illuminating mechanism 196 on an interior of the assembly 100. The at least front, rear, right, and/or left side walls 146, and/or the upper surface 106, may have apertures 200 formed therein such that illumination of the illuminating mechanism is visually perceivable by persons exterior to the trailer stand assembly 100. Illuminating mechanism 196 may comprise a rope or string light, such as an LED light, traversing a general perimeter region of the trailer stand assembly 100, and may be held within apertures 198 formed in support structures 164, as shown in FIGS. 20-22, although it will be appreciated that other types of lights, lighting placement or configurations, and lighting mounts may be used. Illuminating mechanism 196 may serve to provide light to those around the trailer stand assembly 100, such as drivers or pedestrians, which may further improve safety by making more clearly visible the placement of the trailer stand assembly 100, which may also serve to prevent damage to the trailer stand assembly 100, for example during removal of snow from the surface 12 by snow plows. Further, illuminating mechanism 196 may serve to provide messaging to persons viewing the trailer stand assembly 100, such as warning lights indicating that the trailer stand assembly 100 is in operation. For example, the illuminating mechanism 196 may comprise two adjacent LED strip lights, one white and one red. The red LED strip lights may be activated and may also flash (such as once every approximately one second), for example, whenever the moving mechanism 114, such as the first and second hydraulic cylinders 136, 138, are activated, in which case a beeping sound (such as that used for forklifts while reversing) may also activate via warning buzzer or beeper 202, the red LED lighting and the audible beeping indicative of the moving mechanism 114 activation, which may further improve safety by notifying persons in the vicinity of the trailer stand assembly 100 that the trailer stand assembly 100 is in operation. The white LED strip light may be turned off while the red LED lights are flashing, and the white LED strip lights may otherwise remain on (i.e., when the trailer stand assembly 100 is receiving power and the moving mechanism 114 is not in operation).

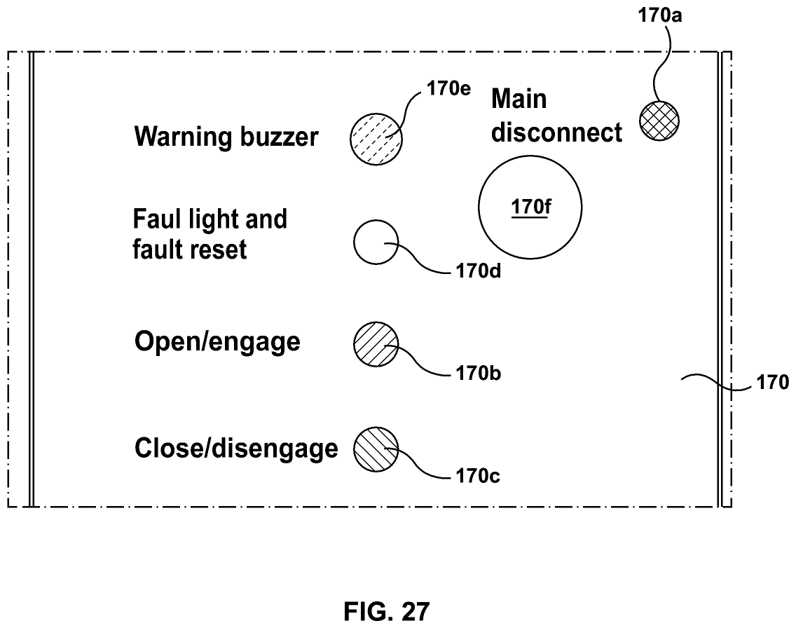

With reference to FIG. 27, in one example embodiment, control device 170 may comprise: a main disconnect 170a; an open or engage button 170b; a close or disengage button 170c; a fault reset button 170d; a warning buzzer light 170e; and an emergency stop or E-stop button 170f. Control device 170 may comprise an integrated audible warning device that sounds when the warning buzzer light 170e is activated. It will be appreciated that the control device 170 may comprise any type of suitable interface as would be known in the art, such as mechanical buttons and/or touch screen buttons, or a combination of such different types of mechanical or digital buttons and/or graphical user interfaces. Further, some or all of the described buttons 170a, 170b, 170c, 170d, and/or 170f may illuminate any suitable colour to communicate an operating state. For example, the open button 170b may illuminate green when activated, the close button 170c may illuminate red when activated, and the fault reset button 170d may also serve as a fault indicator and illuminate red when a fault condition is detected. Further, any of the lights 170a, 170b, 170c, 170d, 170e, and/or 170f may flash a particular colour to indicate a particular state of operation.

An example embodiment of an opening (to the second position) and closing (to the first position) operation will now be described. In accordance with an embodiment, when the extendable support members 108 are in the first, storage or closed position, limit switches 204 sense the closed position (see FIG. 22). The limit switches are communicatively coupled to the control device 170, such as via the electrical junction box 186 and electrical wiring passing through the conduit 160, and upon receipt of the close signal from the limit switches 204, the close button 170c is illuminated red. Upon user activation of the open button 170b, the hydraulic motor of the hydraulic assembly 172 is activated (e.g., a 480 volt AC hydraulic motor) and a 120 volt AC open valve/solenoid is energized. The extendable support members 108 then begin to pivotally transition from the first position to the upright position of the base structures 116 and the raisable structures 118 by way of the first hydraulic cylinders 136, until both limit switches 204 detect the door open condition (i.e., the upright position), and the door open valve is deenergized. During the door open procedure, the open button 170b may illuminate and flash green to indicate active movement of the extendable support members 108.

The hydraulic motor of the hydraulic assembly 172 remains on, and the hydraulic fluid is transitioned under pressure to the second hydraulic cylinders 138 via a hydraulic diverter valve 206. A hydraulic door extend valve/solenoid is energized, and the second hydraulic cylinders 138 cause the raisable structures 118 to extend upward or raise until they meet the underside 110 of a trailer 102, at which point the second hydraulic cylinders 138 continue to apply force against the trailer 102 and build up pressure. Once the pressure reaches a threshold amount, a pressure switch is activated and the extend valve/solenoid is deenergized on the hydraulic power pack. The hydraulic motor of the hydraulic assembly 172 then turns off, and the open button/light 170b may then be illuminated with a solid green colour, to indicate that the trailer stand assembly 100 is in the second position, and that the opening procedure is complete.

In an embodiment, a timer can be associated with each phase of the opening and closing procedure (i.e., from the first position, to the upright position, and to the second position during the opening procedure, and from the second position, to the upright position, and to the first position during the closing procedure), in which case failure to accomplish the particular phase by the associated time limit for that phase triggers a fault condition. For example, the opening of the extendable support members 108 from the first position to the upright position may need to take place within 15 seconds, and the extension of the raisable structures upward until contact is made with the trailer underside 110 and the threshold pressure is reached and the pressure switch is activated may need to take place within 30 seconds of activation of the open button 170b, failure of either of which may result in the fault light 170d and the warning buzzer light 170e to illuminate, as well as any warning buzzer integrated with the control device 170 to sound, and all operation of the trailer stand assembly 100 to stop.

Upon user activation of the close button 170c, the hydraulic motor of the hydraulic assembly 172 is activated and causes the red close button 170c to begin flashing red. A retract valve/solenoid is energized until pressure builds up on a retract pressure switch, and once a threshold pressure is reached, a door close valve/solenoid is energized, and the extendable support members 108 transition from the second position, to the upright position, and to the closed first position, by way of the second and first hydraulic cylinders 138, 136, in a reverse order to the open operation discussed above. A close valve/solenoid remains energized until both limit switches 204 detect the closed condition, at which point the hydraulic motor of the hydraulic assembly 172 turns off and the close button 170c may illuminate a solid red colour, to indicate that the trailer stand assembly 100 is in the first position, and that the closing procedure is complete. In an embodiment, the closing sequence may need to complete within 30 seconds from the time that the close button 170c is activated, failure of which may result in the fault light 170d and the warning buzzer light 170e to illuminate, as well as any warning buzzer integrated with the control device 170 to sound, and all operation to stop.

If the trailer stand assembly 100 experiences a fault condition, the trailer stand assembly 100 may stop, and all power supply to the hydraulic cylinders 136, 138, as well as to the red LED strip light 196 and the warning buzzer or beeper 202, may cease, while the white LED strip light 196 may remain on or be turned on (as appropriate). At the same time, the control device warning buzzer may be activated and the fault light 170d may start flashing, for example, yellow. Fault indicator/light and reset button 170d may be activated by a user to clear the fault condition, once a detected fault has been addressed, which may stop the sounding of the control device warning buzzer and turn off the warning buzzer light 170e and the fault light 170d. The user can then activate the open button 170b or the close button 170c, as appropriate, to activate the open or close sequence, respectively.

Trailer stand assembly 100 may further comprise counterbalance valves 208 associated with each of the first and second hydraulic cylinders 136, 138 to prevent the load on the hydraulic cylinders 136, 138 from collapsing the hydraulic cylinders or causing them to retract. In this way, should a trailer 102 supported by the trailer stand assembly 100 be subjected to a force that would otherwise cause the trailer 102 to collapse, the first and second hydraulic cylinders 136, 138 are expected to remain fixed in their extended positions, which is expected to maintain the trailer 102 in a stable position.

Trailer stand assembly 100 is expected to create enough pressure against the underside 110 of a trailer 102 (such as against at least two support beams on the underside 110 of a trailer 102) that wheel chocks or vehicle restraints may not be necessary to maintain the trailer 102 in a loading dock. In other words, trailer stand assembly 100 may “lock” or fix a trailer 102 into position against a dock.

The trailer stand assembly 100 may be powered by a 480 volt AC 3 phase main power supply. Each heating pad 192 may be powered by a 120 volt AC, 720 watt power supply. Each LED strip light may be powered by 12 volts DC, and in an example embodiment, may be 16 feet long and require 4.4 watts/foot. The hydraulic motor of the hydraulic assembly 172 may be powered by a 480 volt AC, 3 phase, 2 hp power supply, and the warning buzzer or beeper 202 may be powered by a 12 volt DC, 4 amp power supply.

It will be appreciated that the power requirements described above relate only to one possible example embodiment, and that other power supply configurations may be suitable for the trailer stand assembly 100.

The moving mechanism 114 may be any moving mechanism known to persons skilled in the art that is capable of moving the support member(s) 108 between the first, lowered position, any intermediate position, including the upright position, and the second, supporting position, including any suitable hydraulic, pneumatic, electrical, mechanical, magnetic, electromechanical, and the like mechanism (or any combination thereof). It will be understood that combinations of different types of moving mechanisms 114 would be possible in the trailer stand assembly 100.

It will be further appreciated by persons of skill in the art that the trailer stand assembly 100 may be used for supporting loads other than those of trailers 102, and so may have any suitable moniker, such as “support assembly”, “load support assembly”, and the like. As such, the use of the word “trailer” herein, in the name “trailer stand assembly”, is not intended to imply or indicate that use of the presently described invention is necessarily restricted to trailers.

In an example embodiment, in which the trailer stand assembly 100 comprises ramps 158, the support base 104 may be rectangular with dimensions of 104 inches wide by 59 inches long by 6.06 inches high (when in the first position) (the length dimension meaning the a distance spanning from the front to the rear of the trailer stand assembly 100). In the upright position (shown in FIG. 17), the height of the trailer stand assembly 100 (i.e., from the underside of the support base 104 to the contacting surface 132) may be 37 inches, and the distance between centres of the contacting surfaces 132 may be 66.95 inches. Each outer cover 142 may be 26 inches long. In the second position, the height of the trailer stand assembly 100 (i.e., from the underside of the support base 104 to the contacting surface 132) may be 54.68 inches, such that the incremental height from the top edge of an outer cover 142 to a respective contacting surface 132 is 17.68 inches. Each extendable support member 108 may be 4 inches thick, and each contacting surface may be 23.75 inches long. The measurements above are approximate, and it will be appreciated that the above measurements represent only one specific example embodiment of the trailer stand assembly 100, and that further suitable dimensions may be possible for the various components of the trailer stand assembly 100.

By supporting a trailer 102 through contact with contacting surfaces 132 of the one or more extendable support members 108, trailer stand assembly 100 is expected to provide certain benefits. For example, during a trailer loading operation, a forklift entering and exiting a docked trailer, and the loading or unloading of product from the trailer, may cause the trailer to roll and/or pitch (i.e., move or angle up, down, forward, backward, or to a side, or any combination of these movements). Such motion may fatigue the trailer frame and/or all weld and rivet points, as well as the trailer's landing gear 112 (as shown in FIGS. 16, 19 and 26), and the tarmac surface material. Such movement of the trailer may also cause damage to dock equipment, such as the dock bumpers, dock seals or shelters, and dock leveler hinges. As such, the average useful life of a trailer and/or dock structures may be reduced largely due to the forces incurred during trailer loading operations. Further, the wear caused to the leading trailer landing gear 112 by such stresses may cause landing gear to collapse under the loads incurred during a loading operation, or the tarmac to give way, which may result in trailer collapse. A further potential cause of trailer collapse is a heavily loaded trailer nose, which can cause a trailer to tip forward. By supporting a trailer through contact, and in some embodiments, contact under increased pressure (such as hydraulic pressure), trailer stand assembly 100 may reduce the motion of a trailer 102 during loading operations and as such, may increase the life of the trailer, the tarmac and/or all loading dock equipment and components placed under stress during loading operations.

Furthermore, the raisable nature of the raisable structures 118 by way of the second moving mechanisms 114b, including with respect to embodiments having multiple slidably attached raisable structures 118 per extendable support member 108, means that the trailer stand assembly 100 may accommodate a variety of trailer heights. Further still, in embodiments where each extendable support member 108 is moved from the first to the second position by way of a separate moving mechanism, trailer stand assembly 100 is expected to be able to support an overhead load that is not parallel with the surface 12, so that when the raisable structures 118 are in supportive contact with the supported load, raisable structure 118 of one of the extendable support members 108 may be higher or lower than the raisable structure 118 of the other of the extendable support members 108. Trailer stand assembly 100 is also expected to be able to accommodate loading docks that are flat, inclined or declined, and it will be appreciated that the trailer stand assembly 100 may be installed onto a substantially level concrete pad formed atop an inclined or declined loading dock.

The various parts of the trailer stand assembly 10, 100 are constructed of metal, for example steel, aluminum or the like, as discussed above, having the appropriate strength, rigidity and weight characteristics as required and the various parts may be fastened together by welding, bolting, screwing, keying and the like, or a combination thereof, as discussed above.

The above description is that of embodiments of the present invention. Various alterations and changes can be made without departing from the scope and broader aspects of the invention as set forth in the appended claims, which are to be interpreted in accordance with the principles of patent law. Further, the various features described herein of the various described embodiments, including trailer stand assembly 10 and trailer stand assembly 100, may be combined in any suitable manner.

Unless otherwise explained, all technical terms used herein have the same meaning as commonly understood by one of ordinary skill in the art to which this disclosure belongs. Although any methods and materials similar or equivalent to those described herein can be used in the practice for testing of the present invention, the typical materials and methods are described herein. In describing and claiming the present invention, the following terminology will be used.

It is also to be understood that the terminology used herein is for the purpose of describing particular aspects only and is not intended to be limiting. Patent applications, patents, and publications are cited herein to assist in understanding the aspects described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effect of the invention.

It will be understood that any component defined herein as being included may be explicitly excluded from the claimed invention by way of proviso or negative limitation.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

1-24. (canceled)

25. A retractable trailer stand assembly for supporting a trailer, the assembly comprising:
(a) a support base for mounting atop, or at least partially under, a ground surface; and
(b) one or more extendable support members attached to the support base and moveable between a first position and a second supporting position for supporting the trailer by contact with an underside of the trailer.

26. The assembly of claim 25 further comprising a moving mechanism associated with each of the one or more support members for moving the one or more support members between the first and second positions.

27. The assembly of claim 26 wherein each said moving mechanism comprises a first moving mechanism and a second moving mechanism.

28. The assembly of claim 25 wherein each of the one or more extendable support members comprises a base structure and at least one slidably attached raisable structure.

29. The assembly of claim 28 wherein each said at least one slidably attached raisable structure is slidably attached to a respective said base structure or another of said at least one slidably attached raisable structure in adjacent relation.

30. The assembly of claim 28 wherein each of the one or more extendable support members comprises the base structure and one of the at least one slidably attached raisable structure.

31. The assembly of claim 30 wherein each said first moving mechanism is attached at one end thereof to the support base and at another end thereof to a respective said base structure, and wherein each said second moving mechanism is attached at one end thereof to the respective said base structure and at another end thereof to a contacting end of a respective said one of the at least one slidably attached raisable structure.

32. The assembly of claim 31 wherein the respective base structure and slidably attached raisable structure is in a storage position when the respective one of said one or more extendable support members is in the first position, and wherein the respective base structure and slidably attached raisable structure is in an upright position when the respective one of said one or more extendable support members is moved out of the first position by the first moving mechanism, each said first moving mechanism for moving each said base structure and slidably attached raisable structure from the storage position to the upright position, and each said second moving mechanism for slidably raising each said raisable structure until each said raisable structure contacts the underside of the trailer such that each of said one or more extendable support members is in the second position.

33. The assembly of claim 32 wherein each said raisable structure is in a position that is substantially adjacent each said respective base structure when the respective one of said one or more extendable support members is in the first position, and wherein each said raisable structure is at least partially raised out of the substantially adjacent position when the respective one of said one or more extendable support members is in the second position.

34. The assembly of claim 31 wherein each said contacting end comprises a contacting surface for contacting said underside of the trailer when each said one or more extendable support members is in the second position, each said second moving mechanism being attached at said another end thereof to a side of the contacting end that is opposite the contacting surface.

35. The assembly of claim 30 wherein each said first moving mechanism comprises a first hydraulic cylinder and wherein each said second moving mechanism comprises a second hydraulic cylinder.

36. The assembly of claim 35 wherein each said first hydraulic cylinder is pivotally attached at said one end thereof to the support base and pivotally attached at said another end thereof to the respective said base structure.

37. The assembly of claim 36 further comprising an upper surface when each said base structure is in the storage position, and an outer cover attached to each said base structure, the upper surface comprising each said outer cover.

38. The assembly of claim 37 further comprising at least front, rear, right, and left side walls removably attached between the support base and the upper surface with bottom ends of the at least front, rear, right, and left side walls abutting outer edges of the support base and top ends of the at least front, rear, right, and left side walls abutting outer edges of the upper surface, at least the support base, the front, rear, right, and left side walls, and the upper surface forming an enclosure for receiving each of said one or more extendable support members and each of said first and second moving mechanisms when each of the one or more extendable support members is in the first position.

39. The assembly of claim 38 wherein each of the support base and the upper surface has a substantially quadrilateral shape, and wherein the support base has a longer length and a longer width than the length and width of the upper surface such that each of the at least front, rear, right, and left side walls forms a ramp.

40-45. (canceled)

46. The assembly of claim 38 wherein each of the one or more extendable support members is pivotally attached to the support base generally under opposite sides of the upper surface such that when the one or more extendable support members are in the first position, the contacting surfaces are in close adjacent relation to one another.

47. The assembly of claim 46 wherein actuation of each said first hydraulic cylinder causes each said base structure to pivot about said pivotal attachment of each of the one or more extendable support members to the support base so that the one or more extendable support members pivot away from one another until each said base structures and slidably attached raisable structure is in the upright position.

48. The assembly of claim 47 wherein actuation of each said second hydraulic cylinder once each said base structure and slidably attached raisable structure is in the upright position causes each said raisable structure to slidably raise until each said contacting surface of each said raisable structure contacts the underside of the trailer such that each of said one or more extendable support members is in the second position.

49-54. (canceled)

55. The assembly of claim 38 further comprising a temperature sensor and at least one heating pad attached to the support base and positioned between the support base and the one or more extendable support members when in the first position, the temperature sensor communicatively coupled to the at least one heating pad and causing the at least one heating pad to activate when the temperature sensor detects that an ambient temperature is at or below a threshold temperature.

56-57. (canceled)

58. The assembly of claim 38 wherein the assembly further comprises an illuminating mechanism on an interior of the assembly, wherein the at least front, rear, right, and/or left side walls, and/or the upper surface, have apertures formed therein such that illumination of the illuminating mechanism is visually perceivable by persons exterior to the assembly.
